(19) United States
(12) Patent Application Publication
(10) Pub. No.: US 2025/0094533 A1
(43) Pub. Date: Mar. 20, 2025

(54) ARITHMETIC PROCESSING DEVICE AND OPERATING METHOD OF ARITHMETIC PROCESSING DEVICE

(71) Applicant: Fujitsu Limited, Kawasaki-shi (JP)

(72) Inventor: Hiroki Tokura, Yokohama (JP)

(73) Assignee: Fujitsu Limited, Kawasaki-shi (JP)

(21) Appl. No.: 18/824,191

(22) Filed: Sep. 4, 2024

(30) Foreign Application Priority Data
Sep. 15, 2023 (JP) 2023-150192

(51) Int. Cl. G06F 17/16

(52) U.S. Cl. CPC G06F 17/16

(57) ABSTRACT

An arithmetic processing device includes a first memory to hold a matrix, a second memory to hold data obtained by transforming elements in the matrix held in the first memory, a processor to transform the elements in the matrix and cause the second memory to hold the transformed elements by writing each of element-groups arranged in a row direction, which the element-groups are to be used for a matrix-product-operation with a filter in each row of the matrix, to each of a plurality of rows in the second memory in a sequence so that the elements in the element-groups arranged in a column direction of the matrix sequentially partially overlap with each other, and an accelerator to execute a convolution-calculation of the matrix by executing the matrix-product-operation of the filter and the element-groups written in the second memory, which the elements of the element-groups partially overlap with each other.

### CROSS-REFERENCE TO RELATED APPLICATION

This application is based upon and claims the benefit of priority of the prior Japanese Patent Application No. 2023-150192, filed on Sep. 15, 2023, the entire contents of which are incorporated herein by reference.

### FIELD

The embodiments discussed herein relate to an arithmetic processing device and an operating method of an arithmetic processing device.

### BACKGROUND

In recent years, along with the development of convolutional neural networks (CNNs) such as ResNet50, convolution calculations have been widely used. The convolution calculation involves a large amount of calculation because a matrix product operation is repeatedly performed. In many cases, the calculation time accounts for most of a training time of a deep neural network (DNN) including a CNN.

For example, an accelerator such as a graphics processing unit (GPU) equipped with multiple cores including a large number of large matrix-multiplication processors that execute matrix product operations is used to train a DNN. For example, this type of accelerator executes a matrix product operation by using one dimensional input data transformed from two dimensional data by im2col transformation. As a result, the accelerator may efficiently read the input data from the memory and efficiently execute the matrix product operation.

For example, an information processing apparatus makes combinations of matrix processes to be executed in a convolution process, adds up the costs of the matrix processes in each of the combinations, and selecting the combination of the matrix processes having the smallest added-up cost, so that the processing speed of the convolution process may be improved.

For example, the accelerator to execute a matrix product operation includes an im2col engine or an im2col module to execute an im2col transformation. In the transformation by the im2col engine or the im2col module, multiple sets of input data are stored in the memory such that common data portions overlap with each other in accordance with the configuration of the large matrix-multiplication processors, so that the memory capacity is saved.

International Publication Pamphlet No. WO 2020/031281 and U.S. Patent Application Publication Nos. 2022-0066960 and 2020-0133831 are disclosed as related art.

### SUMMARY

According to an aspect of the embodiments, an arithmetic processing device that executes a convolution calculation of a first matrix including a plurality of elements, the arithmetic processing device includes a first memory configured to hold the first matrix, a second memory configured to hold data obtained by transforming the elements in the first matrix held in the first memory, a processor configured to transform the elements in the first matrix and cause the second memory to hold the transformed elements by writing each of a plurality of element groups arranged in a row direction, which the plurality of element groups are to be used for a matrix product operation with a filter in each row of the first matrix, to each of a plurality of rows in the second memory in a sequence so that the elements in the plurality of element groups arranged in a column direction of the first matrix sequentially partially overlap with each other, and an accelerator configured to execute the convolution calculation of the first matrix by executing the matrix product operation of the filter and the plurality of element groups written in the second memory, which the elements of the plurality of element groups partially overlap with each other.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of an arithmetic processing device according to an embodiment;

FIG. 2 is a diagram illustrating an example of an operation of the arithmetic processing device in FIG. 1;

FIG. 3 is a block diagram illustrating an example of an arithmetic processing device according to another embodiment;

FIG. 4 is a diagram illustrating an example of functional blocks of software executed by the arithmetic processing device illustrated in FIG. 3;

FIG. 5 is a diagram illustrating an overview of an operation in a case where the arithmetic processing device illustrated in FIG. 3 executes a convolution calculation on an input image;

FIG. 6 is a diagram illustrating an outline of a convolution calculation process;

FIG. 7 is a diagram illustrating an example of data layout in a case where an input image is transformed for a convolution calculation;

FIG. 8 is a diagram illustrating an example of the sizes of matrices in a matrix product αAb+βC;

FIG. 9 is a diagram illustrating an example of data of an input image transformed in an im2col format;

FIG. 10 is a diagram illustrating an example of data of an input image transformed in an im2col reduced format;

FIG. 11 is a diagram illustrating an example of sizes of data of input images transformed in the im2col format and the im2col reduced format;

FIG. 12 is a diagram illustrating an example in which a multichannel images is input, convolution calculations are executed, and then multichannel images are output;

FIG. 13 is a diagram illustrating an example in which multichannel input images are transformed in the im2col reduced format;

FIG. 14 is a diagram illustrating an example of a layout of elements in multichannel filters for use to obtain multichannel output images;

FIG. 15 is a diagram illustrating an overview of a matrix product operation executed by using the multichannel input images transformed in FIG. 13 and the multichannel filters transformed in FIG. 14;

FIG. 16 is a diagram illustrating an example of description of code for transforming an input image into the im2col reduced format;

FIG. 17 is a diagram illustrating an image in which data transformed into a im2col reduced format in accordance with the code illustrated in FIG. 16 is written to a memory region;

FIG. 18 is a flowchart illustrating an example of a transformation process executed in accordance with the code illustrated in FIG. 16;

FIG. 19 includes flowcharts illustrating examples of processes in operations S140 and S180 in FIG. 18;

FIG. 20 is a diagram illustrating an example of description of code for executing a convolution calculation (matrix product operation) on an input image in the im2col reduced format;

FIG. 21 is a diagram illustrating an example of elements in a matrix stored in a memory when a matrix product operation is executed;

FIG. 22 is a flowchart illustrating an example of a convolution calculation (matrix product operation) process executed in accordance with the code illustrated in FIG. 20;

FIG. 23 is a diagram illustrating an example of execution results of convolution calculations in the im2col format and the im2col reduced format;

FIG. 24 is a diagram illustrating an example of an execution time of each process in the convolution calculation in the im2col reduced format;

FIG. 25 is a diagram illustrating an example of a matrix product operation in a case where an input image in an NCHW layout is input to the arithmetic processing device illustrated in FIG. 3;

FIG. 26 illustrates an example of transformation of an input image into the im2col reduced format by the arithmetic processing device in another embodiment;

FIG. 27 is a diagram illustrating an example of filter movement in a case where there is a stride in the arithmetic processing device in another embodiment;

FIG. 28 is a flowchart illustrating an example of a process of transformation an input image into the im2col reduced format when there is a stride;

FIG. 29 is a flowchart illustrating an example of a process in operation S180A in FIG. 28;

FIG. 30 is a flowchart illustrating an example of a convolution calculation (matrix product operation) process on an input image in the im2col reduced format in a case where there is a stride;

FIG. 31 is a block diagram illustrating an example of an arithmetic processing device in another embodiment; and

FIG. 32 is a flowchart illustrating an example of a process of transformation a matrix into the im2col reduced format and a convolution calculation process by the arithmetic processing device illustrated in FIG. 31.

### DESCRIPTION OF EMBODIMENTS

A method of transforming a matrix into data with little redundancy without depending on a configuration of an accelerator has not been proposed.

Hereinafter, the embodiments of techniques capable of transforming a matrix into data with little redundancy without depending on a configuration of an accelerator will be described with reference to the drawings. In the following description, image data will be simply referred to as an image in some cases.

### Embodiments

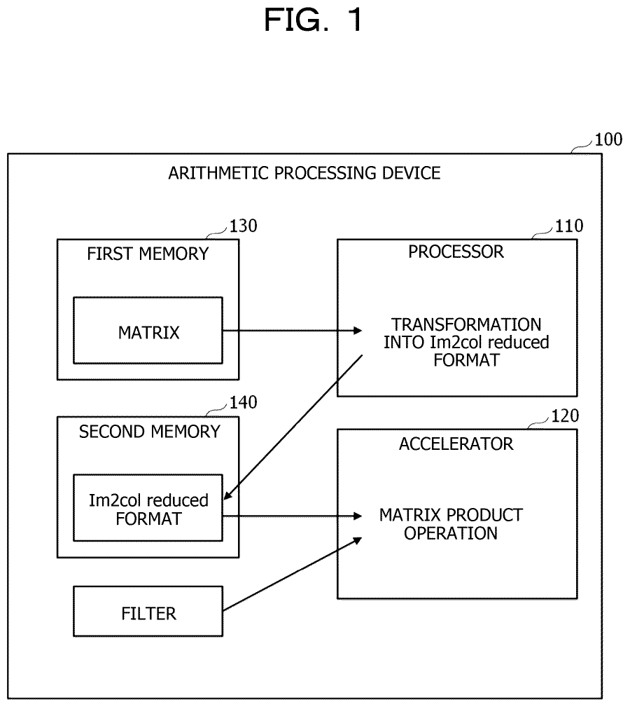

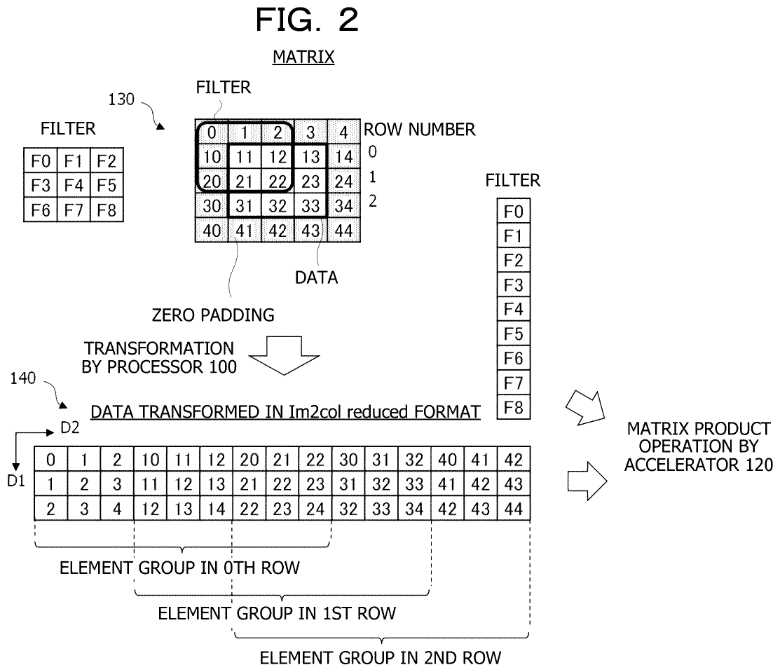

FIG. 1 illustrates an example of an arithmetic processing device in an embodiment. An arithmetic processing device 100 illustrated in FIG. 1 includes a processor 110, an accelerator 120, a first memory 130, and a second memory 140. The first memory 130 holds a matrix to be subjected to a matrix product operation. The matrix may be image data or numerical data. The second memory 140 holds data in which elements in the matrix are transformed in an im2col reduced format illustrated in FIG. 2.

For example, the arithmetic processing device 100 may have a single-chip configuration or a multi-chip configuration. In the case of the multi-chip configuration, each of the processor 110, the accelerator 120, the first memory 130, and the second memory 140 may be configured of a single chip. Alternatively, the processor 110 and the second memory 140 may be configured of a single chip, whereas each of the accelerator 120 and the first memory 130 may be configured of a single chip. The accelerator 120 and the second memory 140 may be configured of a single chip, whereas each of the processor 110 and the first memory 130 may be configured of a single chip.

The arithmetic processing device 100 may be a server. The arithmetic processing device 100 may include multiple processors 110, multiple accelerators 120, multiple first memories 130, and multiple second memories 140 which are coupled to each other via a network, and may have a cloud configuration. A filter may be held in the second memory 140.

The processor 110 reads the matrix held in the first memory 130, transforms elements in the read matrix into an im2col reduced format, and writes the transformed data to the second memory 140. The accelerator 120 includes multiple large matrix-multiplication processors (not illustrated). The accelerator 120 reads the data in the im2col reduced format from the second memory 140 and executes a matrix product operation of the read data with the filter to execute a convolution calculation of the matrix.

FIG. 2 is a diagram illustrating an example of an operation of the arithmetic processing device 100 illustrated in FIG. 1. In the example illustrated in FIG. 2, the matrix to be processed includes elements in 5 rows by 5 columns including data in 3 rows by 3 columns and zero padding arranged around the data. The filter has 3 rows by 3 columns. In the following description, 9 elements in 3 rows by 3 columns having the same size as the filter will be also referred to as an element group. Each element group is a group of elements to be used for a matrix product operation with the filter. The element group may include zero padding.

An element group centered around each of element numbers 11, 12, and 13 is an element group in the zeroth row. An element group centered around each of element numbers 21, 22, and 23 is an element group in the first row. An element group centered around each of element numbers 31, 32, and 33 is an element group in the second row.

In transforming the matrix into data in the im2col reduced format, the processor 110 writes multiple element groups arranged in the row direction of the matrix into respective rows arranged in a first direction D1 of the second memory 140 such that the elements in each element group are written in a sequence along a second direction D2 orthogonal to the first direction D1. Multiple element groups arranged in the column direction are any combination of three element groups centered around the respective element numbers 11, 21, and 31, three element groups centered around the respective element numbers 12, 22, and 32, and three element groups centered around the respective element numbers 13, 23, and 33.

In writing the element groups to the second memory 140, the processor 110 writes the multiple element groups, arranged in the column direction in the matrix, in a sequence along the second direction D2 while partially overlapping the elements in each pair of the element groups adjacent in the column direction. For example, the processor 110 writes each of the multiple element groups arranged in the row direction in each row of the matrix to the corresponding one of the multiple rows in the second memory 140 in a sequence such that the elements in the multiple element groups arranged in the column direction of the matrix sequentially partially overlap with each other. In the example illustrated in FIG. 2, the rows of the second memory 140 are three rows arranged in the first direction D1.

The sizes of the matrix and the filter are not limited to the sizes illustrated in FIG. 2. Also in the case where the size of a matrix is larger than the size in FIG. 2, the processor 110 arranges the multiple element groups arranged in the row direction of the matrix sequentially in the first direction D1 of the second memory 140, and writes the multiple elements in each of the multiple element groups arranged in the row direction in a sequence along the second direction D2 orthogonal to the first direction D1. In writing the element groups to the second memory 140, the processor 110 partially overlaps the elements in each pair of adjacent element groups among the multiple element groups arranged in the column direction in the matrix. This makes it possible to reduce the size of the second memory 140 as compared with the case where the matrix is transformed in an im2col format and written to the second memory 140.

For example, the processor 110 may divide a matrix into multiple submatrices in accordance with the size of the memory region of the second memory 140 or the number of large matrix-multiplication processors of the accelerator 120, and may transform the data in each of the submatrices into data in the im2col reduced format. For example, the transformation of data into the im2col reduced format illustrated in FIG. 2 may be executed without depending on the configuration of the large matrix-multiplication processors in the accelerator 120. For this reason, the process of transformation into the im2col reduced format illustrated in FIG. 2 may be executed on matrices with various sizes by various arithmetic processing devices including processors and accelerators.

The accelerator 120 reads data in each row of the matrix in the im2col reduced format stored in the second memory 140, and executes a matrix product operation between each of the three element groups in each row and the filter. For example, two thirds of the elements in the zeroth row of the matrix may be used for the matrix product operation in the first row of the matrix, and one third of the elements in the zeroth row of the matrix may be used for the matrix product operation in the second row of the matrix.

For this reason, if a register or the like may hold the elements in the zeroth row of the matrix read from the second memory 140, the accelerator 120 may execute the matrix product operation for each of the first and subsequent rows by only reading one third of the elements to be used for the matrix product operation from the second memory 140. Accordingly, the amount of data read from the second memory 140 to the accelerator 120 may be reduced, and the load of access to the second memory 140 by the accelerator 120 may be reduced.

As described above, in this embodiment, it is possible to reduce the size of the second memory 140 as compared with the case where the matrix is transformed in the im2col format and written to the second memory 140. The transformation of a matrix into the im2col reduced format may be executed without depending on the configuration of the large matrix-multiplication processors in the accelerator 120. For this reason, the process of transformation into the im2col reduced format illustrated in FIG. 2 may be executed on matrices in various sizes by various arithmetic processing devices 100 including the processors 110 and the accelerators 120. For example, without depending on the configuration of the accelerator 120, a matrix may be transformed into data in the im2col reduced format, which is data with little redundancy.

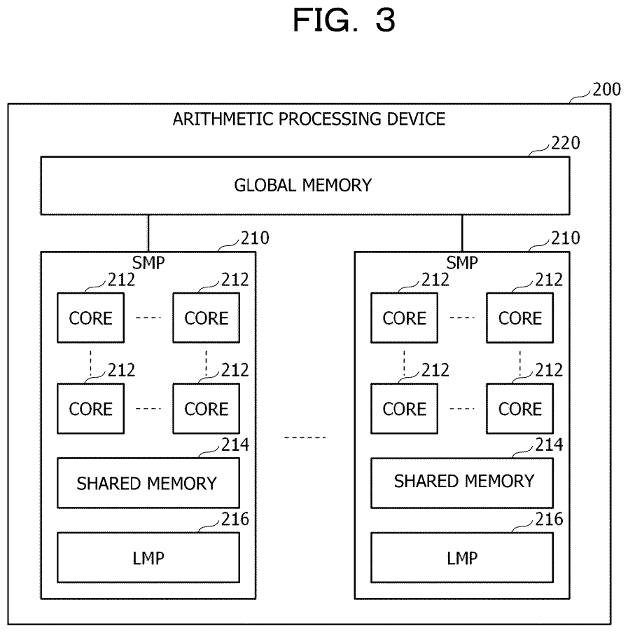

FIG. 3 illustrates an example of an arithmetic processing device according to another embodiment. An arithmetic processing device 200 illustrated in FIG. 3 includes multiple streaming multiprocessors (SMPs) 210 and a global memory 220 used in common by the multiple streaming multiprocessors 210. Each of the streaming multiprocessors 210 is an example of an accelerator, and the global memory 220 is an example of a first memory. For example, the arithmetic processing device 200 may be a graphics processing unit (GPU). Hereinafter, the streaming multiprocessor 210 will be abbreviated as the SMP 210 in some cases.

Each streaming multiprocessor 210 includes multiple cores 212, a shared memory 214 to be used in common by the multiple cores 212, and a large matrix-multiplication processor (LMP) 216 configured to operate as an accelerator. Each core 212 is an example of a processor, and the shared memory 214 is an example of a second memory. Hereinafter, the large matrix-multiplication processor 216 will be abbreviated as the LMP 216 in some cases. For example, the cores 212 may have a function capable of executing multiple data operations in parallel in response to one instruction, such as a single instruction multiple data (SIMD) operation or a single instruction multiple threads (SIMT) operation. Each SMP 210 may have a cache (for example, a last level cache (LLC)).

For example, the shared memory 214 may be a scratch pad memory capable of operating with access latency equivalent to that of the LLC. The shared memory 214 may include a cache. For example, the scratch pad memory is a static random-access memory (SRAM). For example, the global memory 220 has a larger capacity and higher latency than those of the shared memory 214. The global memory 220 may be a three dimensional stacked memory such as a high bandwidth memory (HBM).

The arithmetic processing device 200 may have a single-chip configuration, or a multi-chip configuration including a processor chip including the multiple SMPs 210 and a memory chip including the global memory 220. In this case, for example, the processor chip and the memory chip may be coupled to each other via wiring formed in an interposer disposed over a package substrate.

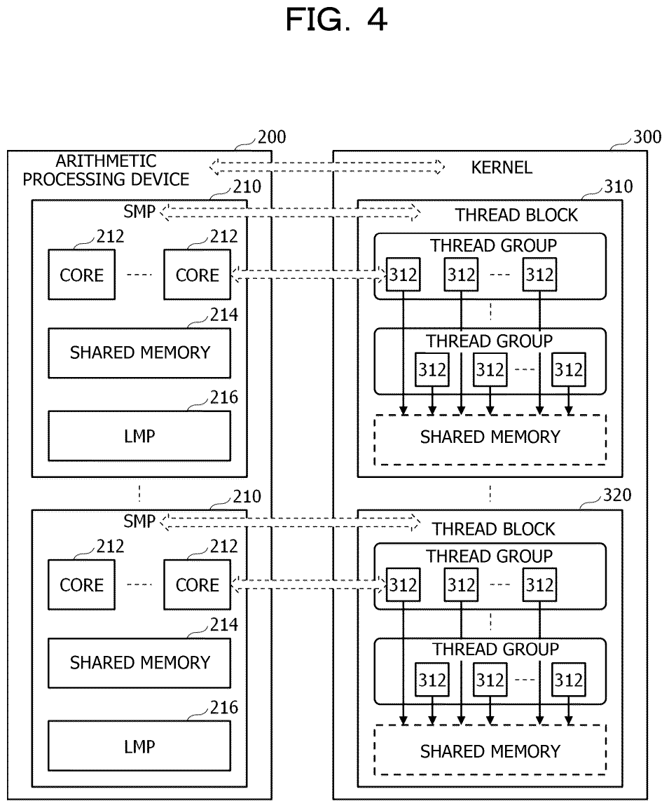

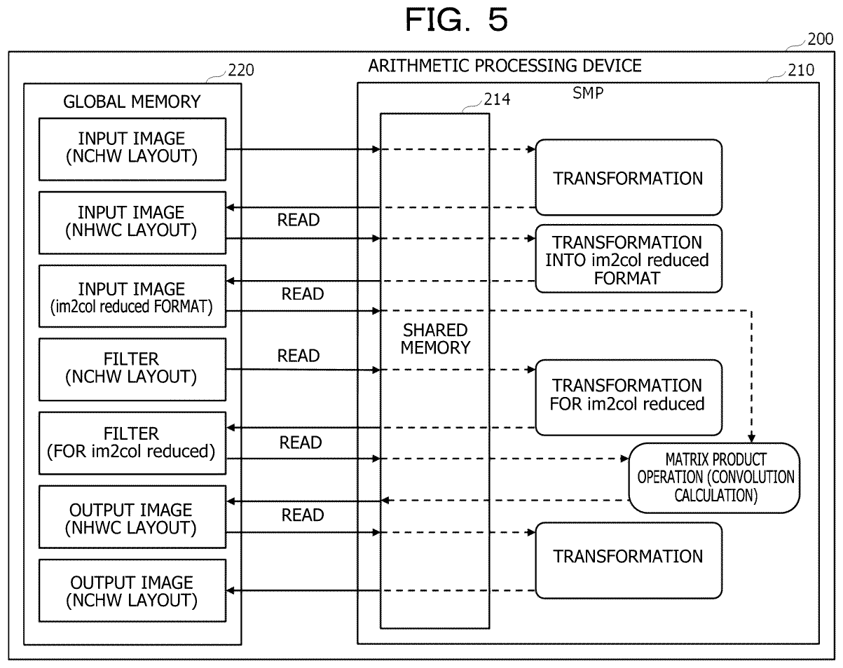

FIG. 4 is a diagram illustrating an example of functional blocks of software to be executed by the arithmetic processing device 200 illustrated in FIG. 3. The arithmetic processing device 200 implements operations illustrated in FIG. 5 and subsequent drawings by executing a kernel 300. The kernel 300 manages multiple threads 312 and enables the multiple cores 212 to respectively execute the multiple threads 312 in parallel.

As a non-limiting example, the multiple threads 312 managed by the kernel 300 are included in any of multiple thread blocks 310 respectively allocated to the SMPs 210. Each of the threads 312 included in each thread block 310 is allocated to any of multiple thread groups. For example, the multiple threads 312 included in each thread group may operate in synchronization with each other and execute the same instruction (process). The multiple threads 312 in each thread block 310 execute processes by using information held in the shared memory 214 included in the SMP 210 to which the thread block 310 is allocated.

FIG. 5 is a diagram illustrating an overview of operations in a case where the arithmetic processing device 200 illustrated in FIG. 3 executes a convolution calculation on an input image. For example, in the global memory 220, storage areas are allocated for holding input images (in NCHW layout and NHWC layout), an input image (in im2col reduced format), filters (in NCHW layout and for im2col reduced), and output images (in NHWC layout and NCHW layout). The arithmetic processing device 200 may execute a convolution calculation of a matrix other than an input image.

Regarding the alphabets in the NCHW layout and the NHWC layout, N denotes a batch, C denotes image channels, H denotes an image height (column), and W denotes an image width (row). In the NCHW layout, the elements in an image are arranged with the higher priority given to the image width W, the image height H, the channels C, and the batch N in this order. In the NHWC layout, the elements in an image are arranged with the higher priority given to the channels C, the image width W, the image height H, and the batch N in this order. For example, the data transformation and the convolution calculation by the SMP 210 may be executed for the number of channels processable at one time with an available memory size in the shared memory 214.

First, the SMP 210 reads an input image in the NCHW layout from the global memory 220 into the shared memory 214, transforms the input image into an input image in the NHWC layout, and stores the resultant input image in the global memory 220 via the shared memory 214. In a case where the input image in the NHWC layout is prepared in advance, the transformation into the NHWC layout is unnecessary.

Next, the SMP 210 reads the input image in the NHWC layout from the global memory 220 to the shared memory 214, converts the input image into the im2col reduced format, and stores the resultant input image in the global memory 220 via the shared memory 214.

The SMP 210 reads filter data in the NCHW layout from the global memory 220 to the shared memory 214, transforms the filter data into filter data for im2col reduced, and stores the resultant filter data in the global memory 220 via the shared memory 214. The input image layout change and transformation into the im2col reduced format and the transformation of the filter may be executed in the reversed order.

Next, the SMP 210 reads the input image (im2col reduced format) and the filter (for im2col reduced) from the global memory 220 to the shared memory, and executes a matrix product operation (convolution calculation). The SMP 210 stores an operation result of the matrix product operation as an output image (NHWC layout) in the global memory 220 via the shared memory 214.

Next, the SMP 210 reads the output image (NHWC layout) from the global memory 220 to the shared memory 214, transforms the read output image to an output image (NCHW layout), and stores the resultant output image in the global memory 220 via the shared memory 214.

As a non-limiting example, the transformation of the input image and the filters may use a cuDNN (deep neural network) function (for example, cudnnTransformTensor), which is a library provided by NVIDIA Corporation. The matrix product operation may use a matrix product function of basic linear algebraic subprograms (CuBLAS) (for example, cublasGemmStridedBatchedEx), which is a linear operation execution library provided by NVIDIA Corporation. In the example illustrated in FIG. 5, the SMP 210 performs the convolution calculation on an input image and outputs an output image. Instead, the convolution calculation may be performed on data other than an image.

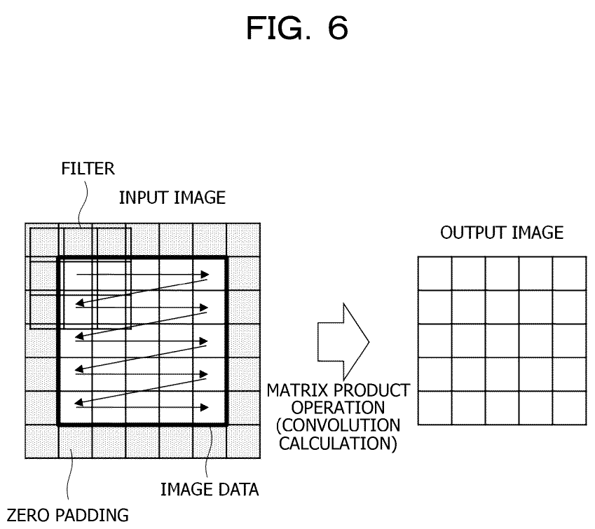

FIG. 6 illustrates an overview of a convolution calculation process. In the example illustrated in FIG. 6, an input image is formed by 49 elements which include 5 vertically-arranged elements by 5 horizontally-arranged elements of image data illustrated in a thick frame and dotted elements added by zero padding around the image data. The matrix product operation (convolution calculation) is executed by using a filter of 3 vertically-arranged elements by 3 horizontally-arranged elements while sequentially moving a window of 3 vertically-arranged elements by 3 horizontally-arranged elements in the input image, and thereby generates an output image having the same size as that of the original image data.

The following description will be given also on the assumption that an input image in which elements are added by zero padding to image data is used, and an output image having the same size as the size of the image data is generated. In the following description, each element in the input image, the filter, and the output image will be also referred to as data.

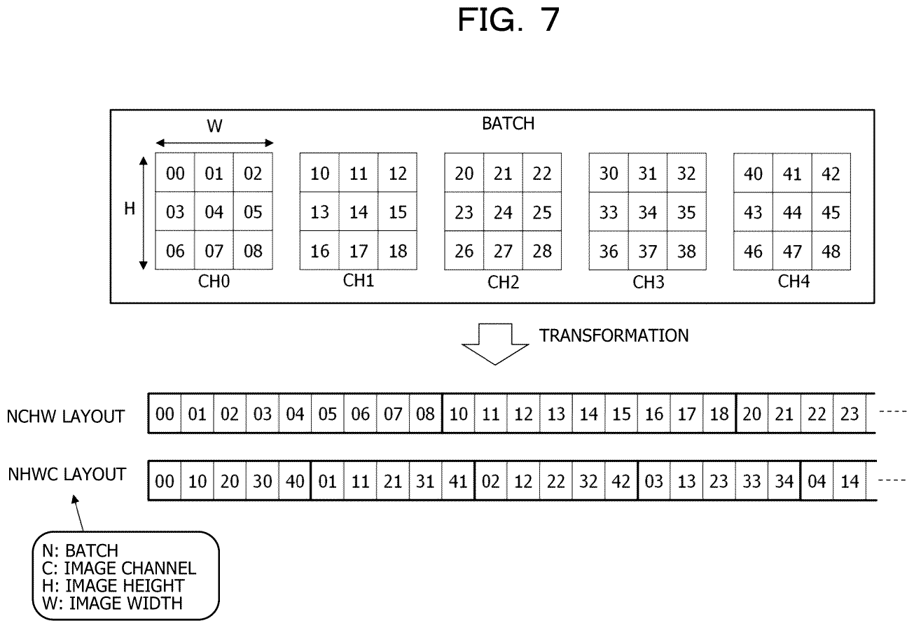

FIG. 7 illustrates an example of data layouts in a case where an input image is transformed for a convolution calculation. In FIG. 7, each of input images designated with channels CH0 to CH4 has 3 vertically-arranged elements by 3 horizontally-arranged elements for simplification of description. For example, in FIG. 7, 8 elements excluding one element at the center in the input image are added by zero padding. In addition, one batch includes the input images of the channels CH0 to CH4.

In the transformation into the NCHW layout, the priority is higher in the order of the image width W, the image height H, and the channels C. For this reason, the elements in the zeroth row, the elements in the first row, and the elements in the second row of the channel CH0 are sequentially extracted and arranged in a memory region or the like. In the same manner, the elements in the next channels CH1 to CH4 are sequentially extracted and arranged in the memory region or the like.

In the transformation into the NHWC layout, the priority is higher in order of the channels C, the image width W, and the image height H. For this reason, the elements are extracted one by one from all the channels CH0 to CH4 by prioritizing the width W, and are arranged in a memory region or the like. In this embodiment, the convolution calculation is executed by using the NHWC layout. For this reason, in a case where an input image is in the NCHW layout, the input image is transformed in advance into an input image in the NHWC layout.

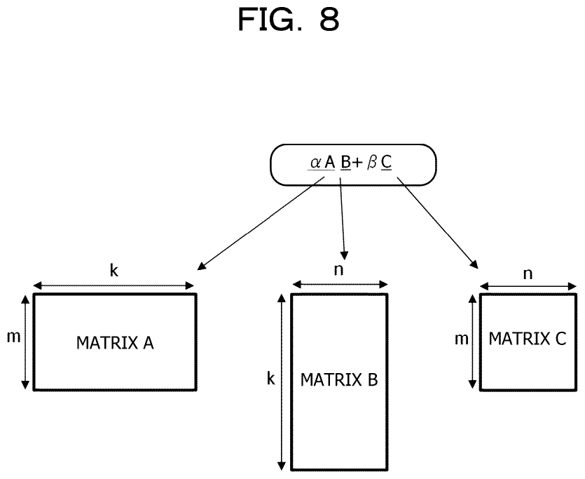

FIG. 8 illustrates an example of the sizes of respective matrices in a matrix product αAb+βC. A matrix product of m rows by n columns is obtained from a matrix A of m rows by k columns and a matrix B of k rows by n columns. For this reason, a matrix C of m rows by n columns may be added to the operation result of the matrix product of the matrices A and B. Here, α and β are coefficients (scalars).

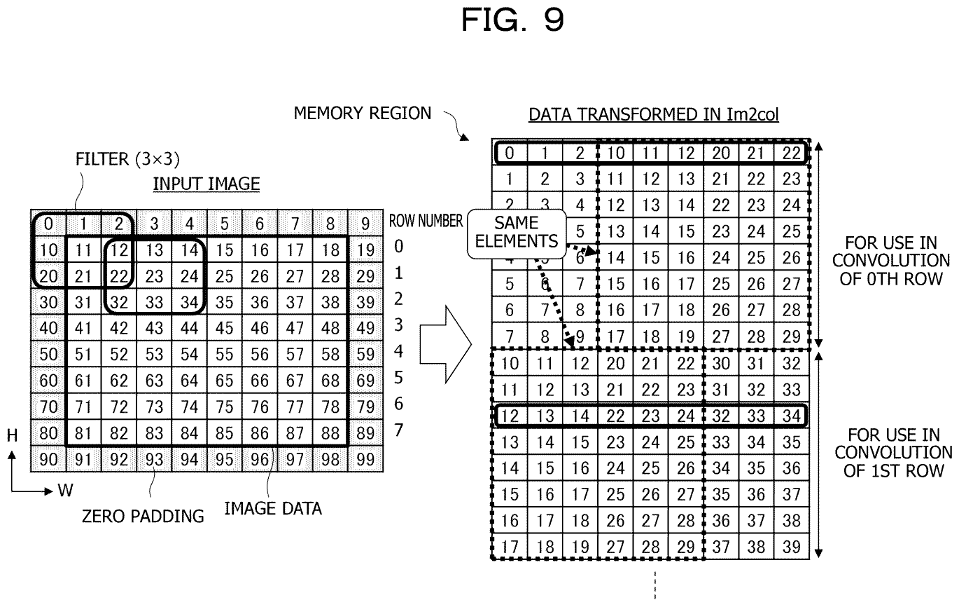

FIG. 9 illustrates an example of data of an input image transformed in the im2col format. FIG. 9 illustrates an example in which one input image is transformed for simplification of description. An input image is in the NHWC layout (substantially HW layout because both the number of batches N and the number of channels C are 1, respectively). The transformation of the input image into the im2col makes it possible to efficiently execute a matrix product operation with the filter. In FIG. 9, an input image including 100 elements in 10 vertically-arranged rows by 10 horizontally-arranged columns in which elements are added by zero padding around 64 elements of image data in 8 vertically-arranged rows by 8 horizontally-arranged columns is transformed. The filter includes 9 elements in 3 vertically-arranged rows by 3 horizontally-arranged columns.

For example, in the transformation into the im2col format, as illustrated in FIG. 6, 9 elements to be sequentially convolved with the filter are arranged in each of rows in a memory region in the shared memory 214 in FIG. 3 or the like. Two sets of 9 elements indicated by two thick frames in the memory region correspond to two sets of 9 elements indicated by two thick frames in the input image, respectively.

Data to be used for convolution of the zeroth row of the input image is arranged in eight rows of the memory region. Similarly, data to be used for convolution of the first row of the input image is arranged in the next eight rows of the memory region. Transformed data in each of the rows specified by row numbers in the input image is sequentially written to every eight rows in the memory region. Although FIG. 9 illustrates the example in which the input image width W (row) is prioritized for transformation, the input image height H (column) may be prioritized for transformation.

In the im2col format, in the memory region in which transformed data is written, the same elements are written in areas indicated by two broken line frames, which poses a problem that the memory region is wastefully used. For example, in the im2col format, the efficiency of a matrix product operation is prioritized and a memory region for holding data for the operation is wastefully used.

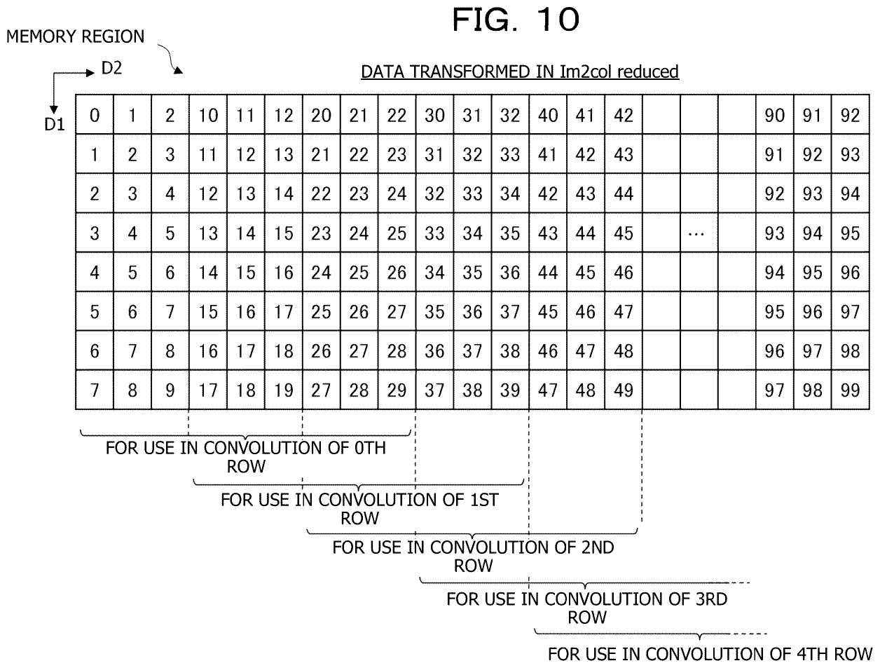

FIG. 10 illustrates an example of data of an input image transformed in the im2col reduced format. An input image to be transformed and a filter to be used for a convolution calculation are the same as the input image and the filter in FIG. 9. FIG. 10 also illustrates an example in which one input image is transformed for simplification of description.

A predetermined number of cores 212 in the SMP 210 illustrated in FIG. 3 write multiple elements in each of the multiple element groups arranged in the row direction of the matrix in the input image illustrated in FIG. 9 to corresponding one of the multiple rows arranged in the first direction D1 in the memory region in a sequence along the second direction D2. In this writing, the elements in adjacent element groups among multiple element groups arranged in the column direction in the input image are written in a sequence along the second direction D2 while partially overlapping with each other. For example, the cores 212 write the elements in the multiple element groups arranged in the row direction in each row of the input image to the respective rows in the memory region in sequences so that the elements sequentially partially overlap with the elements in the multiple element groups arranged in the column direction in the input image.

In the im2col reduced format, the transformed data is written to the memory region so that the data to be used for convolution for three rows in the input image partially overlaps with each other. In the example illustrated in FIG. 10, two thirds of the data to be used for the convolution for the first row overlaps with the data to be used for the convolution for the zeroth row, and one third of the data to be used for the convolution for the second row overlaps with the data to be used for the convolution for the zeroth row.

In the im2col reduced format, in the memory region in which the transformed data is written, the data to be used for the convolution for three rows of the input image is written to the memory region while partially overlapping with each other, which makes it possible to reduce the frequency of redundantly writing the same data to the memory region. Thus, for example, it is possible to save the usage of the shared memory 214 or the like for writing the transformed data.

Accordingly, it is possible to reduce a memory band for writing the transformed data of the input image to the shared memory 214 or the like and a memory band for reading data from the shared memory 214 or the like in order to execute a matrix product operation. As a result, it is possible to improve the processing efficiency of the convolution calculation by the arithmetic processing device 200 as compared with the case where data transformed in the im2col format is used.

Although FIG. 10 illustrates the example in which the elements in the row direction of the memory region are transformed into the im2col reduced format so as to overlap with each other, the elements in the column direction of the memory region may be transformed into the im2col reduced format so as to overlap with each other.

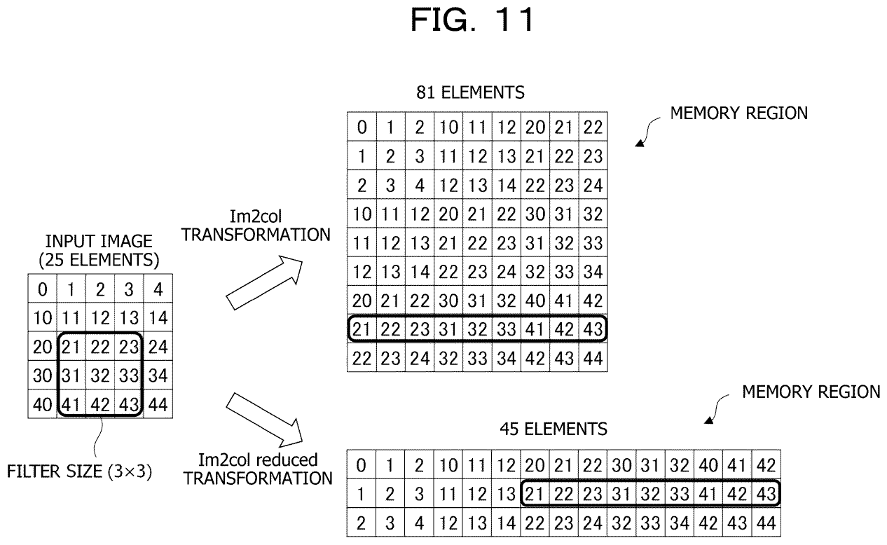

FIG. 11 illustrates an example of sizes of data of input images transformed in the im2col format and the im2col reduced format. An input image is in the NHWC layout (substantially HW layout because both the number of batches N and the number of channels C are 1, respectively). In FIG. 11, the input image includes 5 vertically-arranged elements by 5 horizontally-arranged elements for simplification of description. For example, 16 elements around 9 elements in 3 vertically-arranged elements by 3 horizontal elements in the center of the input image are added by zero padding. Although FIG. 11 illustrates the example in which transformation is performed by prioritizing the width W (row), the transformation may be performed by prioritizing the height H (column).

In the transformation into the im2col format, 81 elements obtained by the transformation are written to a memory region. In contrast, in the transformation into the im2col reduced format, 45 elements obtained by the transformation are written to a memory region. For example, in the example illustrated in FIG. 11, the size of the memory region to which the data transformed in the im2col reduced format is written may be reduced to 56% of the size of the memory region to which the data transformed in the im2col format is written.

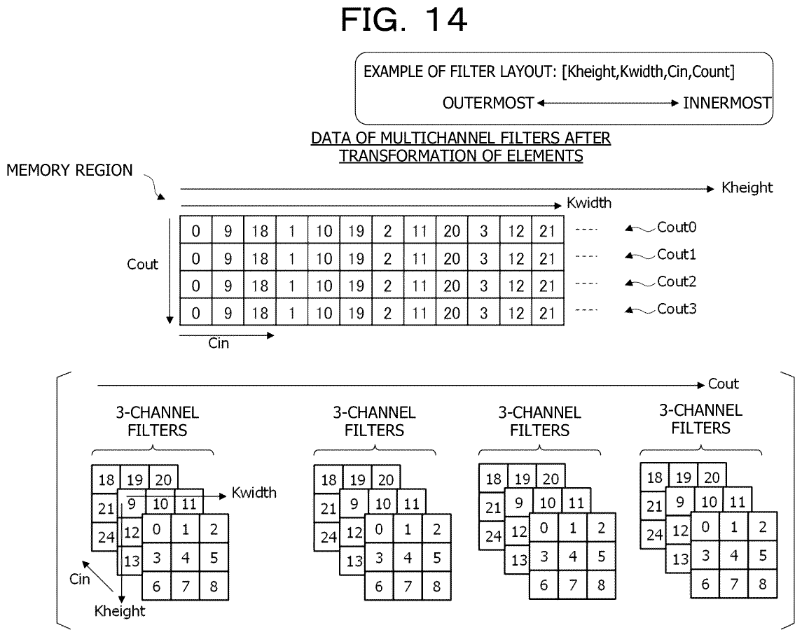

The size of elements in an input image transformed in the im2col format and the size of elements of the input image transformed in the im2col reduced format are expressed by Formulae (1) and (2), respectively. Here, the layout of the input image is the NHWC layout [Batch, Iheight, Iwidth, Cin], and the layout of the filter is [Kheight, Kwidth, Cin, Cout] illustrated in FIG. 14.

Batch*Iheight*Iwidth*Kheight*Kwidth*Cin (1)

Batch*[(Iheight+Kheight−1)*Kwidth*Cin]*Iwidth (2)

In a case where the height Iheight of the input image is sufficiently large, the size of the elements transformed in the im2col reduced format may be 1/Kheight of the size of the elements transformed in the im2col format.

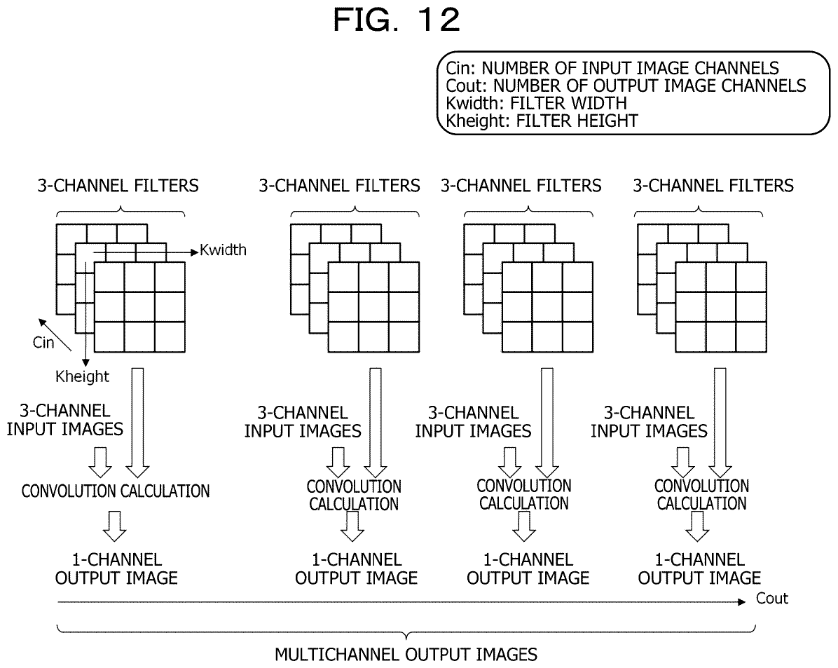

FIG. 12 illustrates an example in which multichannel images are input, the convolution calculations are executed, and then multichannel images are output. In FIG. 12, a reference sign Cin indicates the number of input image channels, and a reference sign Cout indicates the number of output image channels. A reference sign Kwidth indicates a filter width and a reference sign Kheight indicates a filter height.

In the example illustrated in FIG. 12, the convolution calculations for three channels are executed by using 3-channel input images expressing color images such as RGB images and 3-channel filters, and 1-channel output images are generated. The convolution calculation for each of the multiple color images such as RGB images is executed to generate multiple output images.

An example will be described below in which, as illustrated in FIG. 12, four groups of 3-channel input images are transformed in the im2col reduced format and then 4-channel output images are generated by the convolution calculations. However, the number of input image channels and the number of output image channels are not limited to those in the example illustrated in FIG. 12.

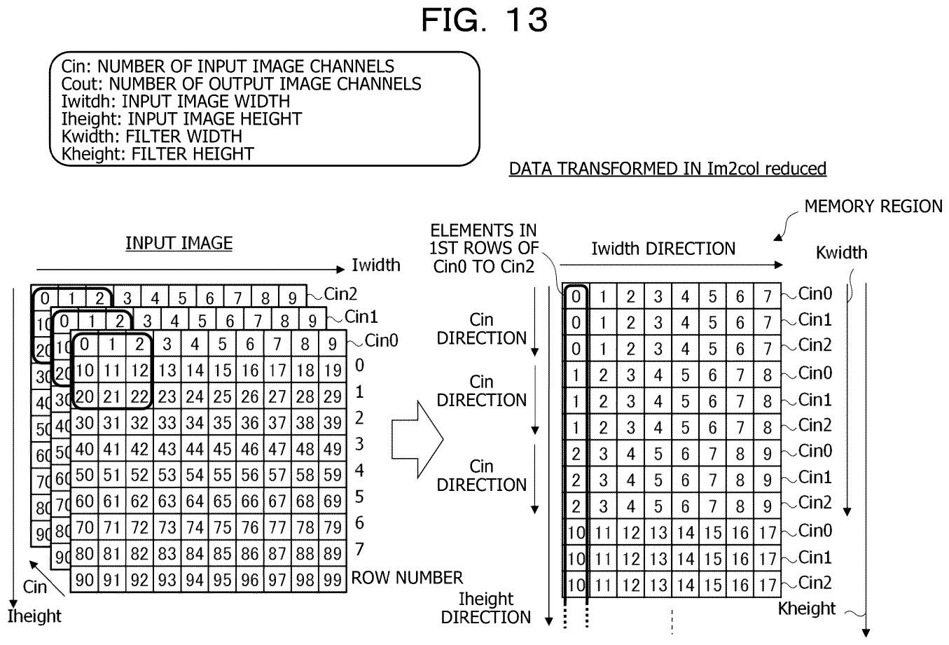

FIG. 13 illustrates an example in which multichannel input images are transformed into the im2col reduced format. In FIG. 13, 3-channel input images having the same size as in FIG. 9 are transformed in the im2col reduced format. In FIG. 13, a reference sign Iwidth indicates an input image width (column direction), and a reference sign Iheight indicates an input image height (row direction). The channels of the input image are denoted by Cin0, Cin1, and Cin2, respectively. In FIG. 13, the Iwidth direction and the Iheight direction of the elements transformed in the im2col reduced format are interchanged with respect to FIG. 10.

In the case of multichannel input images, elements in channels Cin0 to Cin2 are arranged in the im2col reduced format one after another in the Iheight direction (row direction) of a memory region. For this reason, for example, first 9 elements indicated by a thick frame in each of the channels Cin0 to Cin2 of the input images are written to the first column indicated by a thick frame in the memory region. The convolution calculation on the transformed data illustrated in FIG. 13 is performed by using 3-channel filters to obtain a 1-channel output image. By repeating the process of transformation each group of 3-channel input images illustrated in FIG. 13 into the im2col reduced format and writing the transformed input images to the memory region, it is possible to obtain data strings to be used for generating multiple output images by the convolution calculation.

FIG. 14 illustrates an example of layouts of elements in multichannel filters to be used to obtain multichannel output images. The elements in each filter and the elements in each input image before transformation are in the NHWC layout. For example, the multichannel filters are transformed by prioritizing the number of output image channels Cout, the number of input image channels Cin, the file width Kwidth, and the filter height Kheight in this order. For example, as indicated by [Kheight, Kwidth, Cin, Cout] in FIG. 14, the filter is transformed with the number of output image channels Cout set at innermost and the filter height Kheight set at outermost.

In the case where an input image is in the NHWC layout, the layout of the filter is often [Kheight, Kwidth, Cin, Cout]. In this case, the elements in the filter do not have to be transformed.

In the example illustrated in FIG. 14, the multichannel filter data after the element transformation includes filter elements corresponding to four output images Cout0 to Cout3 arranged in the Cout direction. The filter elements corresponding to the four output images Cout0 to Cout3 may be the same as or different from each other. Each of the rows of the filter arranged in the Cout direction include elements to be used for the convolution calculation of the 3-channel input images.

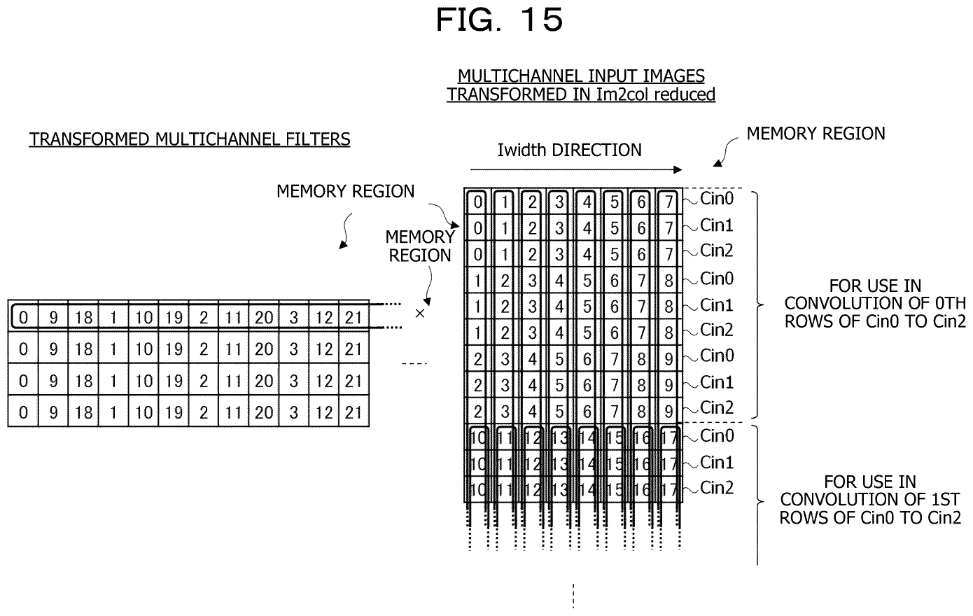

FIG. 15 illustrates an overview of a matrix product operation executed using the multichannel input images transformed in FIG. 13 and the multichannel filters transformed in FIG. 14. For example, a matrix product operation of 9 elements×the channels Cin0 to Cin2 (9 elements×3 channels indicated by the thick frames) of the input images, which are arranged in the vertical direction of the memory region, is executed by using the elements in the filter indicated by a thick frame arranged in the horizontal direction of the memory region. The matrix product operations may be executed in parallel (concurrently) for 8 sets of 9 elements×3 channels arranged in the width direction Iwidth of the input image.

After the convolution calculation in the zeroth rows of the channels cin0 to cin2, the convolution calculations in the first to seventh rows of the channels cin0 to cin2 are sequentially executed by using the same filter. For example, a batch matrix product is executed. At this time, as described with reference to FIG. 10, some of the elements in the input images on which the convolution calculation is executed are the same as some of the elements used in the first previous row and some of the elements used in the second previous row.

As illustrated in FIG. 12, when there are four groups of 3-channel input images, the matrix product operation process illustrated in FIG. 15 is repeatedly executed four times (loop process). In this process, the matrix product operation of the second group of 3-channel input images is executed by using the elements in the second row of the filter. The matrix product operation of the third group of 3-channel input images is executed by using the elements in the third row of the filter. The matrix product operation on the fourth group of 3-channel input images is executed by using the elements in the fourth row of the filter.

When the constraint imposed by the number of threads 312 illustrated in FIG. 4 is satisfied, the elements in four groups of 3-channel input images corresponding to the elements in the four rows of the filter may be arranged in the Iwidth direction of the memory region. In this case, the matrix product operations of the four groups of 3-channel input images may be executed in parallel.

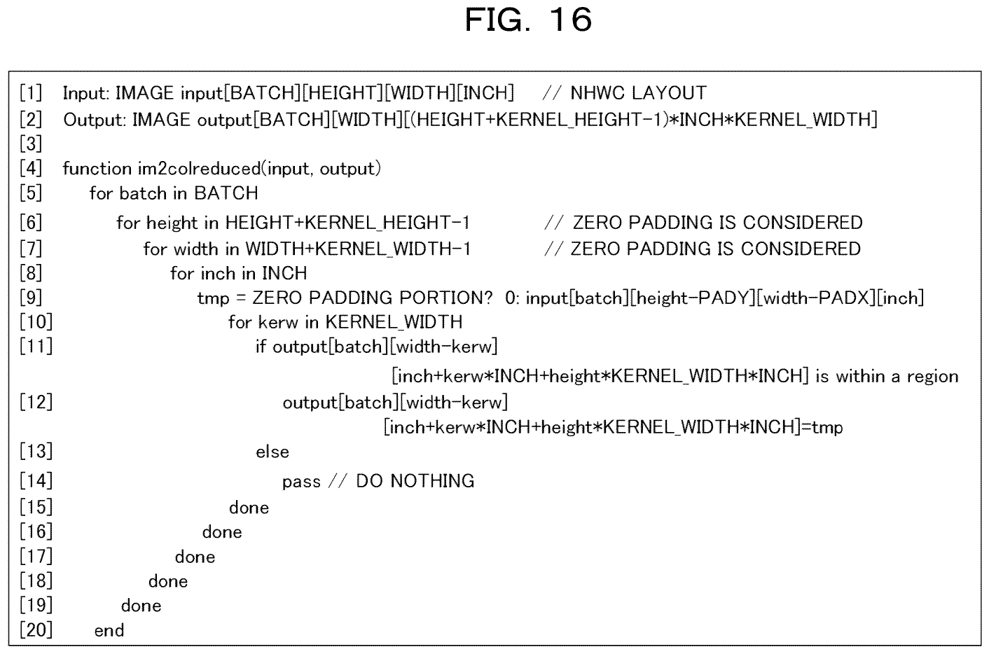

FIG. 16 illustrates an example of description of code for transforming input images into the im2col reduced format. The code illustrated in FIG. 16 is source code written in C language, and is executed by the cores 212 in FIG. 3 after the code is compiled into object code executable by the cores 212. A number in an angle bracket at the left end of the description of the code indicates a row number.

For example, a function name of the code for transforming the input images into the im2col reduced format is im2colreduced. Input images are transformed into the NHWC layout in advance, so that [BATCH] is outermost and [INCH] is innermost in the image input in the first row. Although the input images have multiple dimensions, the input images are developed in one dimension and stored in a memory region in the shared memory 214 or the like. An output image is an image transformed in the im2col reduced format.

Among variables used in the code illustrated in FIG. 16, variables input from the outside are presented below.
BATCH: number of batches
HEIGHT: image (image data) height
WIDTH: image (image data) width
INCH: image channels
KERNEL_HEIGHT: filter height
KERNEL_WIDTH: filter width

A constant PADY in the code indicates the number of zero padding elements in the image height direction, and a constant PADX in the code indicates the number of zero padding elements in the image width direction. The constants PADY and PADX are set as follows based on KERNEL_HEIGHT and KERNEL_WIDTH input from the outside.

PADY=(KERNEL_HEIGHT−1)/2

PADX=(KERNEL_WIDTH−1)/2

Variables batch, height, width, inch, and kerw are index variables corresponding to the batch, the height direction of the input image, the width direction of the input image, the channel direction of the input image, and the lateral width direction of the kernel, respectively. A variable tmp is used to temporarily store the read elements in the input image. When “BATCH” of “batch in BATCH” in the code is “3”, the variable batch is 0, 1, or 2. When “BATCH” is “2”, the variable batch is 0 or 1.

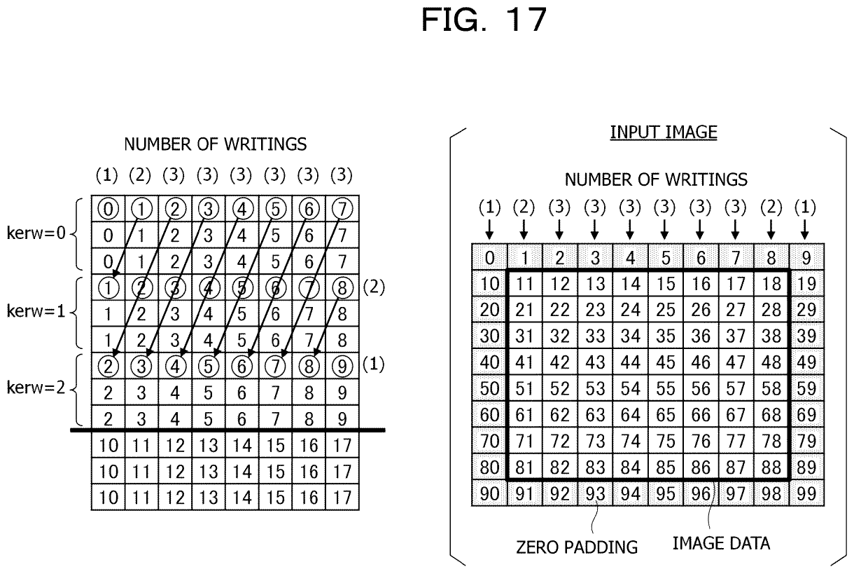

FIG. 17 illustrates an image in which the data transformed into the im2col reduced format in accordance with the code illustrated in FIG. 16 is written to a memory region. The writing of the data to the memory region is performed while shifting a data-write position in the memory region in a loop in lines 10 to 15 of the code illustrated in FIG. 16.

For example, the data in the columns “(1)” of zero padding at the left end and the right end of the input image is written to the memory region once as indicated with one circle. The data in the columns “(2)” that are the each of second columns from the left end and the right end of the input image is written to the memory region twice as indicated by two circles. The data in the columns “(3)” that are the third column from the left end of the input image to the third column from the right end of the input image is written to the memory region three times as indicated by three circles.

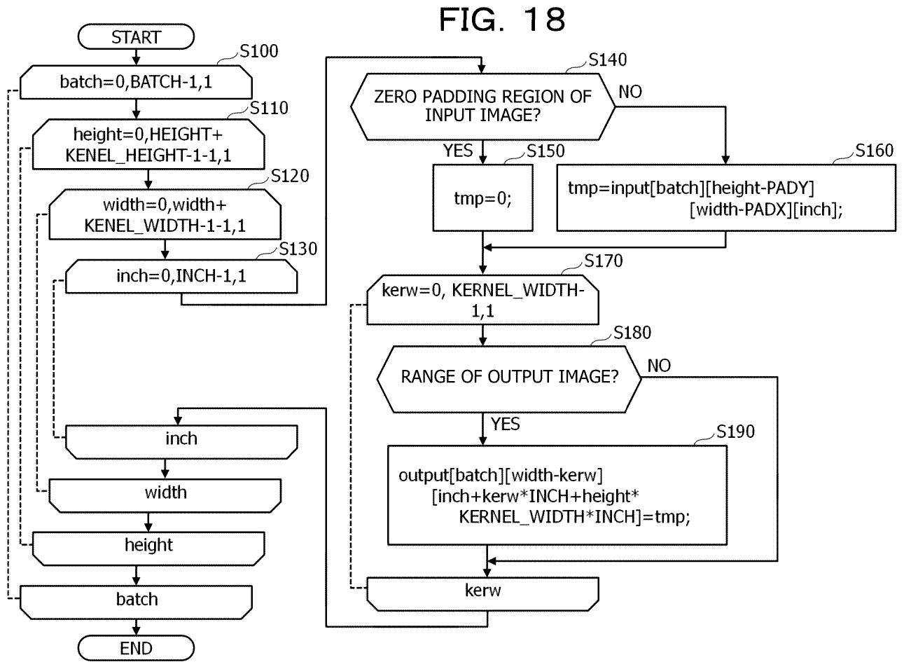

FIG. 18 illustrates an example of a transformation process executed in accordance with the code illustrated in FIG. 16. Since the transformation of the input image into the Im2col reduced format in each batch is independent of the other batches, the transformation is executed on a batch-by-batch basis (operation S100).

In each batch, depending on the filter height, the elements in the input image in the height direction including zero padding are set as transformation targets and the transformation process is executed on each of the elements in the height direction (each row) (operation S110). In each batch, depending on the filter width, the elements in the input image in the width direction including zero padding are set as transformation targets and the transformation process is executed on each of the elements in the width direction (each column) (operation S120). In a loop in operation S130, the input image in the channel direction is transformed into the im2col reduced format. The input image in the NHWC layout may be sequentially acquired and transformed by accessing the elements in the consecutive direction in the memory region as described above.

As illustrated in FIG. 17, zero padding is included in the input image to be processed in the convolution calculation. For this reason, in operation S140, it is determined whether the accessed element of the input image is a zero padding region or an image data region. In the case of the zero padding region, the variable tmp is set to 0 in operation S150. In the case of the image data region, the read target element of the image data is read as the variable tmp in operation S160.

In a loop in operation S170, the processes in operations S180 and S190 are executed at each of the positions in the width direction of the filter (0,1, and 2 in this embodiment). In operations S180 and S190, if the element acquired in operation S150 or S160 is used depending on the index variable kerw in the lateral width direction of the filter, the element is written to a position in the memory region at the corresponding column of the output image and the row corresponding to the index variable kerw.

For example, in a case where the arithmetic processing device 200 in FIG. 3 has an SIMD arithmetic function or an SIMT arithmetic function capable of efficiently processing a large number of consecutive elements, it is possible to efficiently acquire a large number of elements in an input image. For example, in a case where an input image in the NHWC layout is transformed, it is possible to efficiently acquire the elements in the channel direction inch of the input image by setting the channel direction inch inside the loop.

Since the elements in the input images are transformed with the channel direction inch of the input images set inside the loop, the elements in the output images are also consecutive in the channel direction inch. Accordingly, the elements may be transformed and efficiently written to the memory region as the output images. As illustrated in FIG. 17, since it is possible to write each read element in the input images to the memory region at most the number of times corresponding to the filter width, it is possible to further improve the writing efficiency.

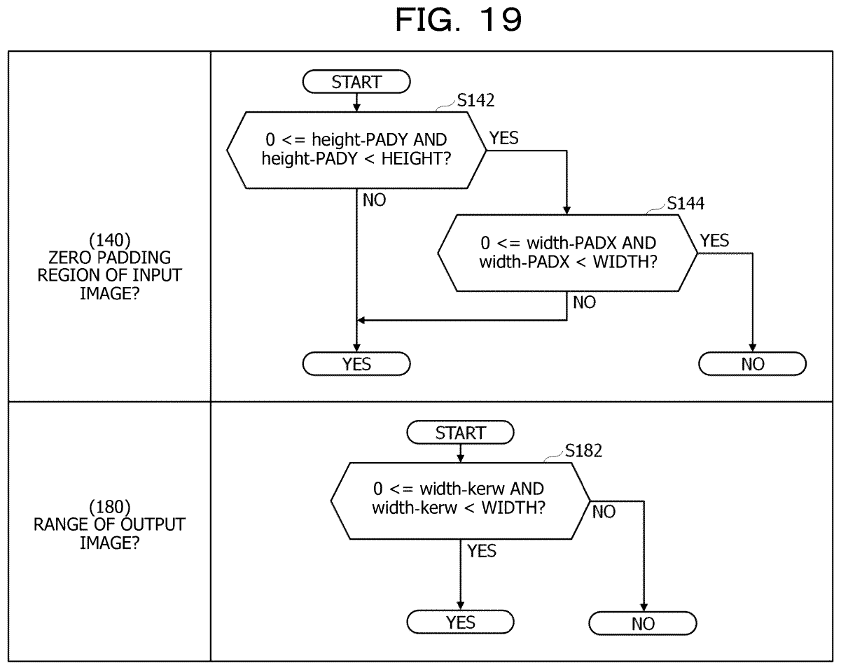

FIG. 19 illustrates an example of the processes in operations S140 and S180 in FIG. 18. In operation S140, the core 212 determines that the element is the zero padding region if any of determination results in operations S142 and S144 is negative (NO), or determines that the element is not the zero padding region if both the determination results in operations S142 and S144 are affirmative (YES).

In operation S180, the core 212 determines that the element is in the range of the output image if a determination result in operation S182 is affirmative (YES), or determines that the element is not in the range of the output image if the determination result in operation S182 is negative (NO).

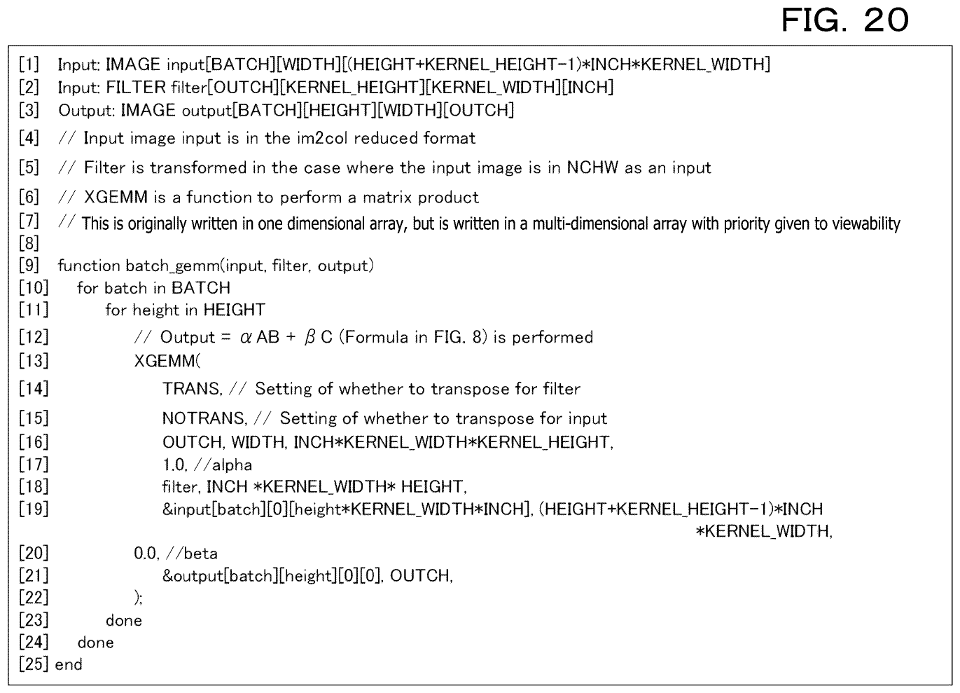

FIG. 20 illustrates an example of description of code for executing a convolution calculation (matrix product operation) on an input image in the im2col reduced format. The code illustrated in FIG. 20 is source code written in C language as in FIG. 16, and is executed by the core 212 in FIG. 3 after the code is compiled into object code executable by the core 212. A number in an angle bracket at the left end of the description of the code indicates a row number.

For example, a function name of the code for executing a convolution calculation on an input image in the im2col reduced format is batch_gemm, and XGEMM is a function for executing a matrix product operation. In the code illustrated in FIG. 20, an input image in the im2col reduced format and a filter transformed according to the case where the input image is in the NCHW layout are input, and a result of the convolution calculation is output. The same variables as the variables used in FIG. 16 are used in FIG. 20. A variable OUTCH denotes output image channels.

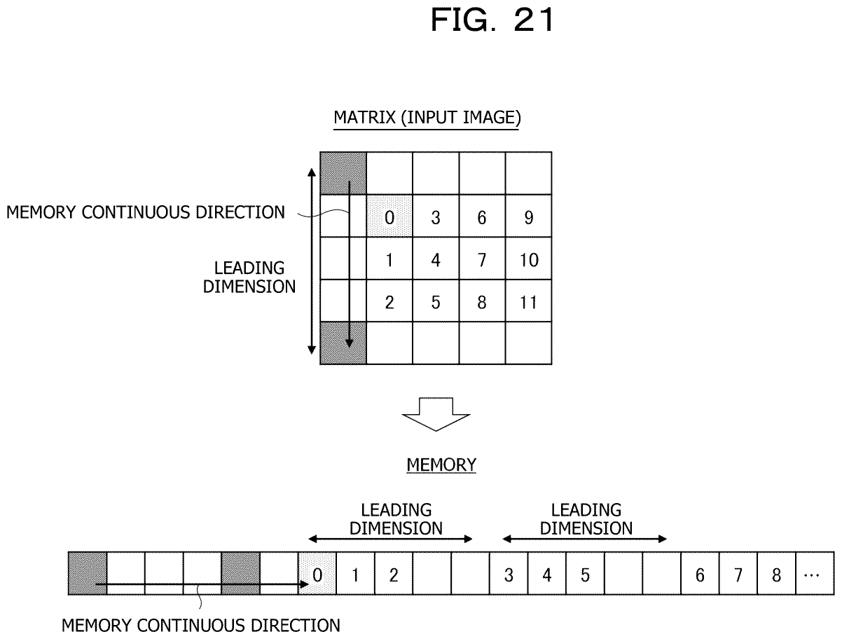

FIG. 21 illustrates an example of elements in a matrix stored in a memory when a matrix product operation is executed. For example, a matrix assumed in a matrix product operation included in BLAS, which is the linear operation execution library, is based on the assumption that the elements in the matrix (for example, an input image) are stored in a memory in column-major order. In BLAS, a matrix product operation may be executed by designating submatrices included in a large matrix. At this time, focusing on the first element on which the matrix product operation is executed, the number of elements up to the first element in the next column is treated as a leading dimension, and the leading dimension of a matrix A is denoted by Ida.

In a case where a matrix A and a matrix B are desired to be used after being transposed when the matrix product operation is executed, the function is called by designating whether or not to transpose the matrices as illustrated in the following description example.
dgemm(
character TRANSA, (← designate whether to transpose the matrix a for calculation)
character TRANSB, (← designate whether to transpose the matrix b for calculation)
integer M,
integer N,
integer K,
double precision ALPHA,
double precision, dimension (Ida,*) A,
integer LDA, (← the leading dimension of the matrix A)
double precision, dimension (Idb,*) B,
integer LDB, (← the leading dimension of the matrix B)
double precision BETA,
double precision, dimension (Idc,*) C,
integer LDC (← the leading dimension of the matrix C) )

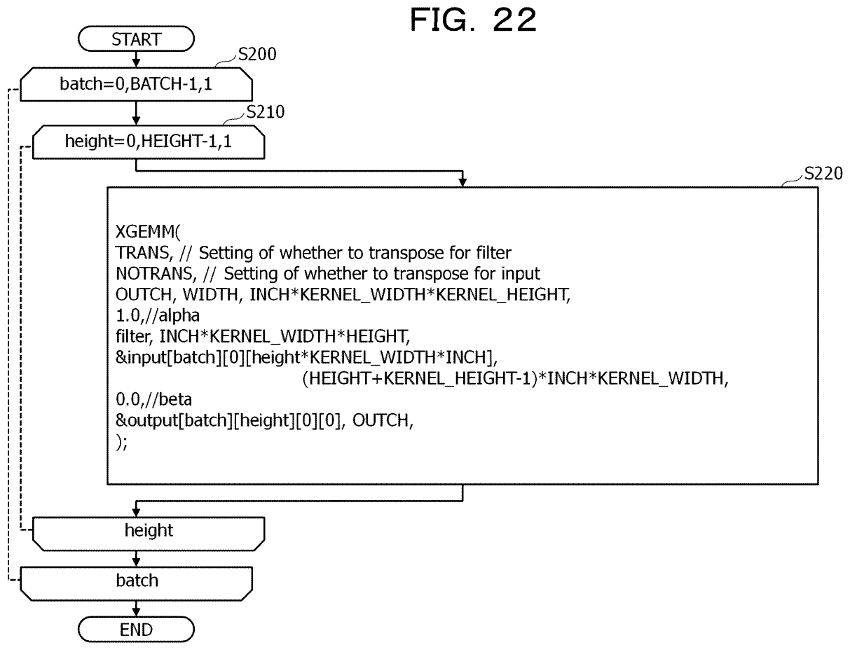

FIG. 22 illustrates an example of a convolution calculation (matrix product operation) process executed in accordance with the code illustrated in FIG. 20. Since the convolution calculation (matrix product operation) in each batch is independent of the other batches, the convolution calculation is executed on a batch-by-batch basis (operation S200). Since the filter is common to the batches, the pointer does not have to be moved.

When the image is transformed in the im2col reduced format, the convolution calculation is performed by executing the matrix product operation for each index in the height direction of the image. For this reason, it is possible to execute the convolution calculation for the entire input image (operation S210) by executing the matrix product operation the number of times corresponding to the image (image data) height HEIGHT.

In the input image in the im2col reduced format, the images of multiple channels overlap with each other in the height direction of the image as illustrated in FIG. 13. For this reason, it is possible to execute the correct calculation by only shifting the head pointer by the product of the filter width KERNEL_WIDTH and the input channel INCH for each loop. Since the output image that is the result of the convolution calculation is calculated for each batch in the height direction of the image, the output image may be shifted for each loop by the product of the output channel OUTCH and the image (image data) width WIDTH (operation S220).

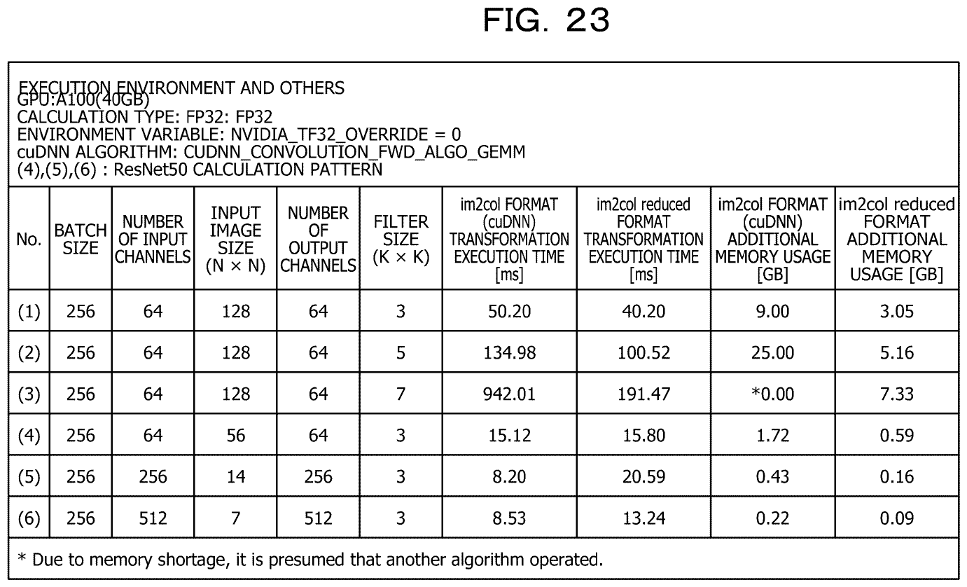

FIG. 23 illustrates an example of the execution results of convolution calculations in the im2col format and the im2col reduced format. The convolution calculations were performed with a single-precision floating-point number (FP32) by using A100, which is a GPU manufactured by NVIDIA Corporation. NVIDIA_TF32_OVERRIDE=0 was used as an environmental variable, and CUDNN_CONVOLUTION_FWD_ALGO_GEMM was used as an algorithm of cuDNN.

The convolution calculations were executed for six patterns in which the number of input channels, the size of an input image, the number of output channels, and the size of a filter were changed. In No. 1 to No. 3, the convolution calculations were executed with the number of input channels, the size of the input image, and the number of output channels fixed but with the size of the filter changed. In No. 4 to No. 6, the convolution calculations were executed with a filter portion of 3 rows by 3 columns extracted from ResNet50, which is one of the benchmarks.

In No. 1 to No. 3, the time of transformation into the im2col reduced format is shorter than the time of transformation into the im2col format. In No. 1 to No. 3, the additional memory usage for the im2col reduced format is approximately 1/filter size (height or width) of that usage for the im2col format.

For the cuDNN calculation in No. 3, an additional memory of 49 GB had to be used for the data transformed in the im2col format, and exceeded the memory (40 GB) equipped in the GPU that executed the convolution calculation. For this reason, presumably, the memory failed to be secured and another algorithm operated.

In the case of ResNet50, the time of transformation into the im2col reduced format is longer than the time of transformation into the im2col format, but the additional memory usage for the im2col reduced format was successfully reduced to approximately one third of that usage for the im2col format.

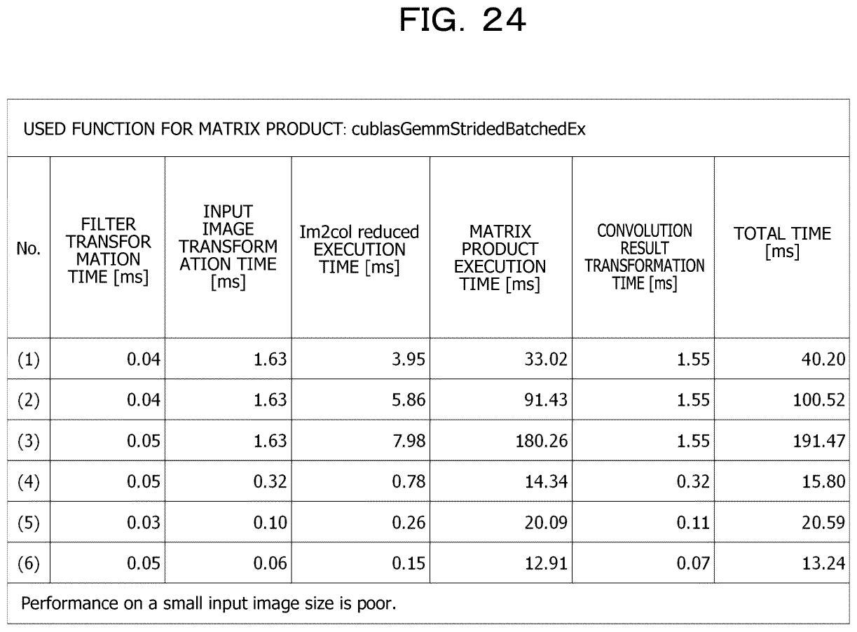

FIG. 24 illustrates an example of an execution time of each process in the convolution calculation in the im2col reduced format. The batch size, the number of input channels, the size of an input image, the number of output channels, and the size of a filter in No. 1 to No. 6 are the same as those in No. 1 to No. 6 in FIG. 23, respectively. A matrix product function cublasGemmStridedBatchedEx of CuBLAS was used in the convolution calculations.

As seen in No. 4 and No. 6, in the case where the size of the input image is relatively small, the execution time of the matrix product operation is longer than in the other matrix product operations. This is presumably because the matrix product function used is unsuitable for an input image in small size.

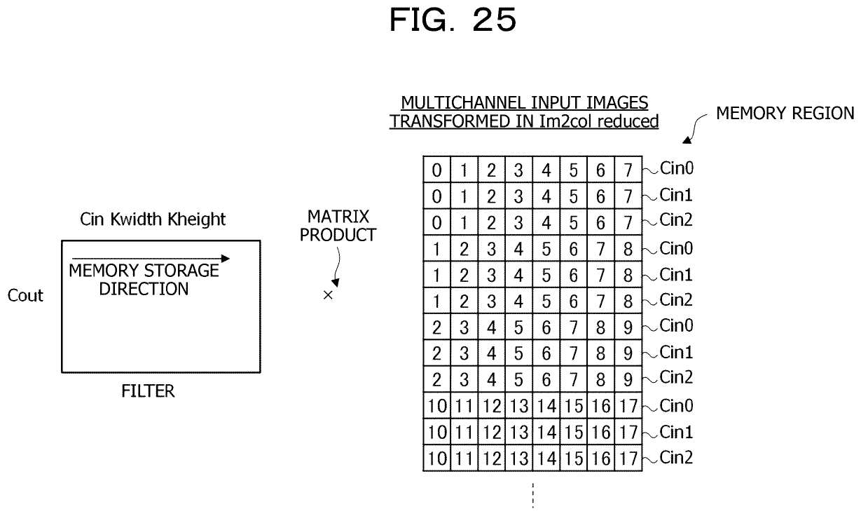

FIG. 25 illustrates an example of a matrix product operation in a case where an input image in the NCHW layout is input to the arithmetic processing device 200 in FIG. 3. Detailed description of the same elements as in FIG. 13 will be omitted herein. In a case where an input image is in the NCHW layout, the arithmetic processing device 200 transforms the input image in the NCHW layout into the NHWC layout and then transforms the resultant input image into the im2col reduced format.

In the case where the input image is in the NCHW layout, a filter in [Cout, Cin, Kheight, Kwidth] format corresponding to the NCHW layout is input to the arithmetic processing device 200. In this case, the arithmetic processing device 200 treats the filter as an image, and transposes the filter into the NHWC layout [Cout, Kheight, Kwidth, Cin]. The arithmetic processing device 200 executes a matrix product operation of the transposed filter and the input image in the im2col reduced format.

This embodiment described above is also capable of producing the same effects as in the foregoing embodiments. For example, the transformation of an input image into the im2col reduced format may be executed without depending on the configuration of the large matrix-multiplication processors mounted in the LMPs 216 and the size of the input image. This makes it possible for various arithmetic processing devices including cores and accelerators to execute the process of transformation into the im2col reduced format with little redundancy and the convolution calculation process.

Since the input image may be transformed into data in the im2col reduced format with little redundancy, the size of the memory region for holding the transformed data may be reduced. For example, the number of elements in the input image holdable in the shared memory 214 after being transformed into the im2col reduced format may be increased as compared with the case where the input image is transformed into the im2col format.

In this embodiment, multiple input images arranged in the Cin direction are transformed in the im2col reduced format in such a way that the elements at the same position in the element groups at the same position in the multiple input images are adjacently written to the same row of the memory region. Regarding multiple filters respectively used for matrix product operations of the multiple input images arranged in the Cin direction, elements at the same position in the multiple filters are adjacently held in one row of the memory region.

This makes it possible to execute the matrix product operations of the multiple input images in parallel by using the data of the multiple input images arranged in the Cin direction transformed into the im2col reduced format and written to the memory region. As a result, it is possible to improve the processing performance of the convolution calculations by efficiently using the large matrix-multiplication processors that execute the matrix product operations.

In a case of execution of convolution calculations on multiple input image groups which each include multiple input images arranged in the Cin direction and which are arranged in the Cout direction, the filters respectively for the multiple input image groups are held in different rows in the memory region. The multiple filters to be repeatedly used are held in the memory region in advance, and the matrix product operations of the multiple input images arranged in the Cin direction are sequentially executed by reading the corresponding filters from the memory region. As result, it is possible to efficiently execute the convolution calculations.

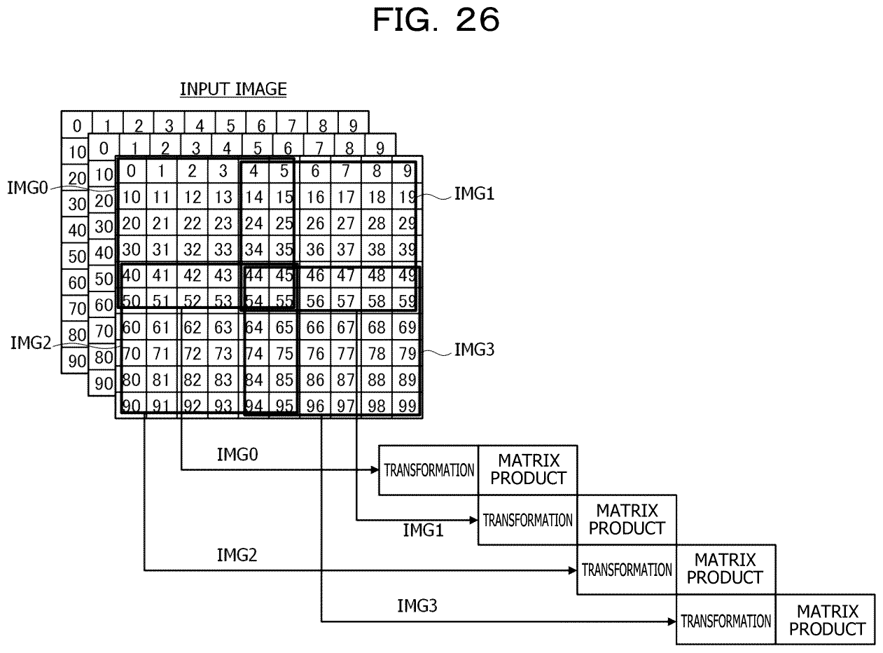

FIG. 26 illustrates an example of transformation of an input image into the im2col reduced format by the arithmetic processing device in another embodiment. The transformation into the im2col reduced format illustrated in FIG. 26 is executed by the arithmetic processing device 200 illustrated in FIG. 3.

For example, the arithmetic processing device 200 divides an input image into multiple images IMG (IMG0 to IMG3) and transforms each of the images IMG into the im2col reduced format. In this case, every time the image IMG is transformed, the arithmetic processing device 200 executes the matrix product operation on the transformed image IMG, so that the second or subsequent transformation process may be hidden by the matrix product operation process. Accordingly, in a case where the input image is transformed in the im2col reduced format to save the usage of the shared memory 214, it is possible to make the time taken for the transformation process unnoticeable.

This embodiment described above is also capable of producing the same effects as in the foregoing embodiments. For example, the transformation of an input image into the im2col reduced format may be executed without depending on the configuration of the large matrix-multiplication processors mounted in the LMPs 216 in FIG. 3 and the size of the input image. This makes it possible for various arithmetic processing devices including cores and accelerators to execute the process of transformation into the im2col reduced format with little redundancy and the convolution calculation process.

In this embodiment, it is also possible to hide the transformation process with the matrix product operation process by executing the transformation into the im2col reduced format for each of the images IMG to which the input image is divided and executing the matrix product operation on the transformed image IMG. Accordingly, in a case where the input image is transformed in the im2col reduced format to save the usage of the shared memory 214, it is possible to make the time taken for the transformation process unnoticeable.

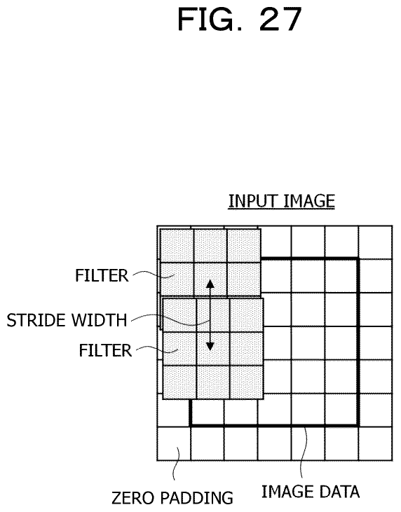

FIG. 27 illustrates an example of filter movement in a case where there is a stride in the arithmetic processing device in another embodiment. Processes illustrated in FIGS. 27 to 30 are executed by the arithmetic processing device 200 in FIG. 3.

When there is a stride, the size of elements in an input image transformed in the im2col format and the size of elements in the input image transformed in the im2col reduced format are expressed by Formulae (3) and (4), respectively. In Formulae (3) and (4), a reference sign stridey denotes a stride width in the height direction, and a reference sign stridex denotes a stride width in the width direction. Here, the layout of the input image is the NHWC layout [Batch, Iheight, Iwidth, Cin], and the layout of the filter is [Kheight, Kwidth, Cin, Cout] illustrated in FIG. 14.

Batch*Iheight/stridey*Iwidth/stridex*Kheight*Kwidth*Cin (3)

Batch*[(Iheight+Kheight−1)*Kwidth*Cin]*Iwidth/stridex (4)

As illustrated in FIG. 27, the filters partially overlap each other. In a case where elements in the vertical direction are overlapped with each other, (stride width stridey)<(filter height Kheight). When (stride width stridey)<(filter height Kheight), the number of elements transformed in the im2col reduced format may be smaller than the number of elements transformed in the im2col format.

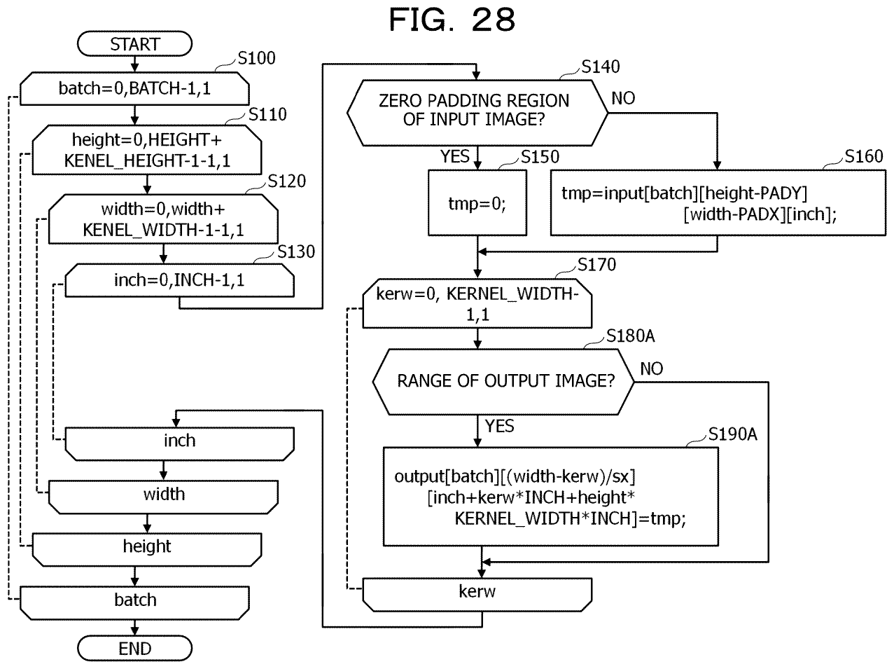

FIG. 28 illustrates an example of a process of transformation an input image into the im2col reduced format in a case where there is a stride. The process illustrated in FIG. 28 is executed by the core 212 in FIG. 3. The detailed description of the same processes as in FIG. 18 will be omitted by using the same operation numbers. The transformation process illustrated in FIG. 28 is the same as the transformation process illustrated in FIG. 18 except that operations S180A and S190A are executed instead of operations S180 and S190 in FIG. 18.

In the transformation process illustrated in FIG. 28, writing data to the memory region in operation S190A is performed for each stride width sx. For this reason, in operation S180A, it is checked whether or not the element (data) which is about to be written to the memory region is a write target element. As illustrated in FIG. 27, since the filters overlap each other in the height direction, elements are written in the height direction regardless of a stride number.

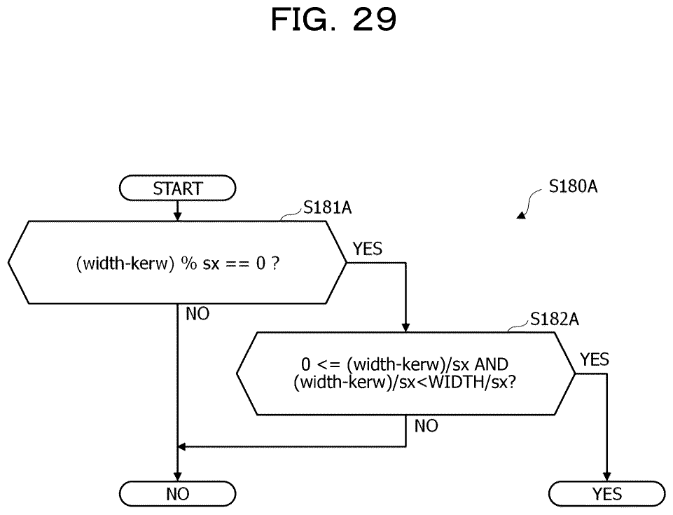

FIG. 29 illustrates an example of a process in operation S180A in FIG. 28. Since the core 212 performs writing while skipping elements when there is a stride, the core 212 checks whether or not an element of interest in the horizontal direction of the input image is a write target element and whether or not the element is in a write target range when transforming the input image.

The core 212 executes operation S182A if the input image width width is exactly divisible by the kernel width kerw in operation S181A, or if terminates the process illustrated in FIG. 29 because the element is not an output target. The core 212 determines that the element is in the range of the output image if the determination result in the operation S182A is affirmative (YES), or determines that the element is not in the range of the output image if the determination result in the operation S182A is negative (NO).

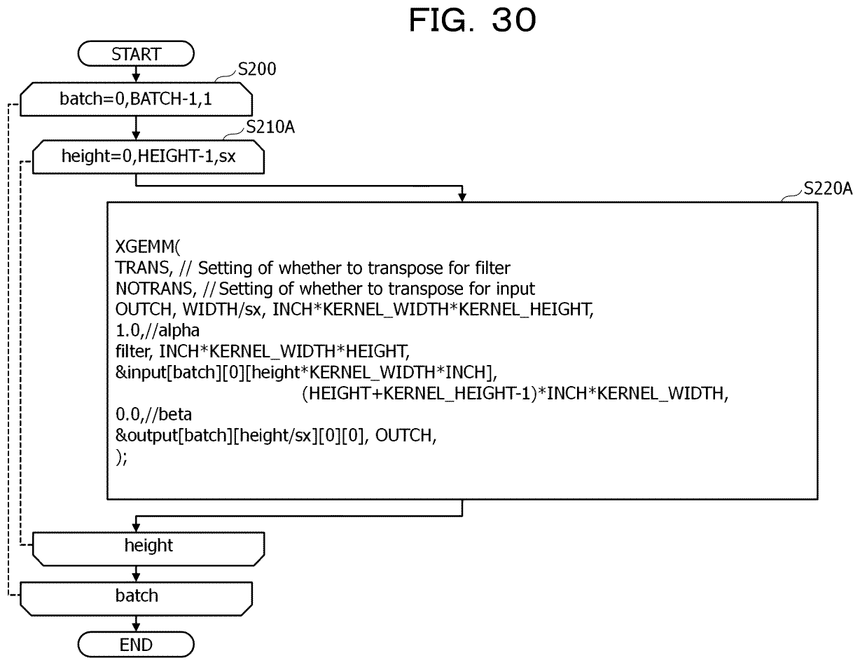

FIG. 30 illustrates an example of a convolution calculation (matrix product operation) process of an input image in the im2col reduced format in a case where there is a stride. The detailed description of the same process as in FIG. 22 will be omitted. In a loop in the height direction (height), the LMP 216 executes a convolution calculation while skipping elements according to the stride and therefore executes a matrix product operation for each stride width SX.

For example, the LMP 216 in FIG. 3 executes the convolution calculation in the horizontal direction of the input image by one matrix product operation. In this case, since the convolution calculation is executed for each stride width, the number of convolutions in the horizontal direction of the input image decreases. When there is a stride, the number of image outputs in the height direction is smaller than when there is no stride, and thus the pointer to be shifted in the height direction of the output image is adjusted according to the stride width.

This embodiment described above is also capable of producing the same effects as in the foregoing embodiments. For example, the transformation of an input image into the im2col reduced format may be executed without depending on the configuration of the large matrix-multiplication processors mounted in the LMPs 216 and the size of the input image. This makes it possible for various arithmetic processing devices including cores and accelerators to execute the process of transformation into the im2col reduced format with little redundancy and the convolution calculation process.

In this embodiment, even in a case where there is a stride, it is possible to save the memory capacity of the memory region for storing the input image to be used for the convolution calculations by executing the convolution calculations after transforming into the im2col reduced format.

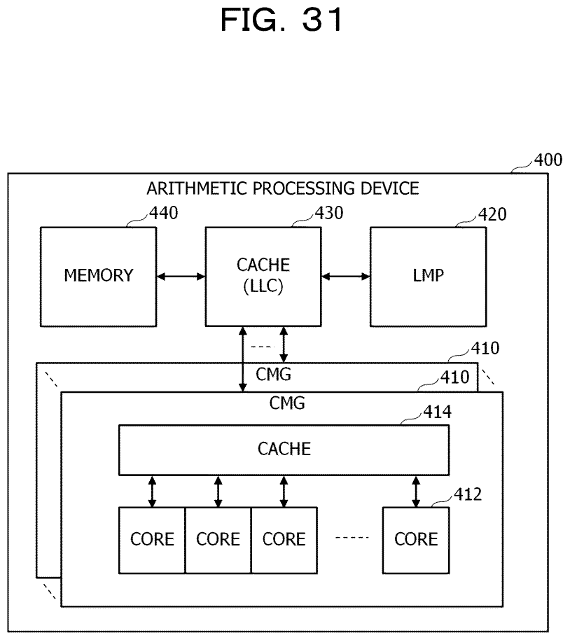

FIG. 31 illustrates an example of an arithmetic processing device in another embodiment. An arithmetic processing device 400 illustrated in FIG. 31 includes at least one core memory group (CMG) 410, a large matrix-multiplication processor (LMP) 420, a cache (last level cache (LLC)) 430 shared by the multiple core memory groups 410, and a memory 440. In the following description, the core memory group 410 will be also abbreviated as the CMG 410, the large matrix-multiplication processor 420 will be also abbreviated as the LMP 420, and the cache 430 will be also abbreviated as the LLC 430.

Each CMG 410 includes multiple cores 412 and a cache 414 shared by the multiple cores 412. Each core 412 may include a primary cache, and in this case, the cache 414 functions as a secondary cache. The CMG 410 is an example of a core group, the LLC 430 is an example of a second memory, and the memory 440 is an example of a first memory. The LMP 420 is an example of an accelerator.

The arithmetic processing device 400 may have a single-chip configuration or a multi-chip configuration. In the case of the multi-chip configuration, the CMG 410 and the LLC 430 may have a chip configuration, whereas the LMP 420 and the memory 440 may each have a chip configuration. The arithmetic processing device 400 may function as an information processing device such as a server. The LMP 420 is an example of an accelerator capable of operating asynchronously with the core 412 and executing a matrix product operation.

For example, the memory 440 may be a main storage device such as an HBM or a double data rate synchronous dynamic random-access memory (DDR-SDRAM). The LLC 430 may include a scratch pad memory, or a scratch pad memory may be disposed instead of the LLC 430.

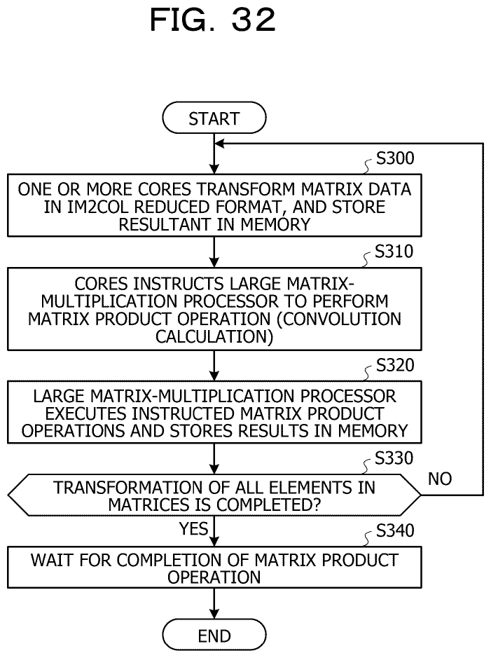

FIG. 32 illustrates an example of a process of transformation a matrix into the im2col reduced format and a convolution calculation process performed by the arithmetic processing device 400 in FIG. 31. The detailed description of the same operations as in the above-described embodiments will be omitted. For example, the arithmetic processing device 400 may execute transformation of elements in a matrix of an input image or the like on a matrix-by-matrix basis or may divide a matrix of an input image or the like into four submatrices and execute transformation of the elements on a submatrix-by-submatrix basis as illustrated in FIG. 26. The arithmetic processing device 400 may execute the transformation of a matrix of a multichannel input image or the like illustrated in FIG. 13 on a matrix-by-matrix basis or may divide the matrix and execute the transformation on a submatrix-by-submatrix basis.

For example, in transformation of elements in a matrix, the cores 412 executes the transformation for each group of elements to be transformed. Each core 412 may execute transformation of elements included in one of subdivided regions in each of multiple submatrices into which a matrix is divided. Execution of the transformation of the elements in the submatrices into which the matrix is divided or the subdivided regions of each of the submatrices makes it possible to execute multiple transformation processes and multiple matrix product operation processes in parallel as illustrated in FIG. 26. The time taken for the transformation process may be hidden by the matrix product operation. One iteration of the loop in the flowchart illustrated in FIG. 32 illustrates an example in which the cores 412 transform the elements in submatrices into which a matrix is divided.

In the flowchart illustrated in FIG. 32, the transformation of the elements in the matrix is executed by the cores 412 in FIG. 31, and the matrix product operations are executed by the large matrix-multiplication processor 420 in FIG. 31.

First, in operation S300, the arithmetic processing device 400 operates one or more cores 412 to transform data in the matrix of an input image or the like. Before the transformation process, the matrix of the input image or the like is transferred from the memory 440 to the LLC 430 or the scratch pad memory in the LLC 430. The transformed data may be held in the LLC 430 or the scratch pad memory included in the LLC 430.

In the case where the matrix is transformed in the im2col reduced format, the size of the memory for holding the transformed data may be reduced as compared with the case where the matrix is transformed in the im2col format. For example, a limited memory capacity may be effectively used. For this reason, in a case where the transformed data is held in the LLC 430, the possibility of writing the data back to the memory 440 may be reduced, and a decrease in the processing efficiency of the subsequent matrix product operation may be suppressed.

Next, in operation S310, the cores 412 instruct the LMP 420 to execute the matrix product operations using the transformed data and the filter. Next, in operation S320, the LMP 420 executes the matrix product operations instructed by the cores 412, and stores the execution results of the matrix product operations in a memory. For example, the memory in which the execution results are stored is the LLC 430 or the scratch pad memory in the LLC 430.

Next, in operation S330, the cores 412 execute operation S340 when the transformation of all the elements in the matrix or the submatrices is completed. The cores 412 return to operation S300 when the transformation of the elements in the matrix or the submatrices is not completed. In operation S340, the cores 412 wait for the completion of the matrix product operations by the LMP 420, and ends the process illustrated in FIG. 32 when the matrix product operations are completed.

This embodiment described above is also capable of producing the same effects as in the foregoing embodiments. For example, the transformation of an input image into the im2col reduced format may be executed without depending on the configuration of the large matrix-multiplication processor mounted in the LMP 420 and the size of the input image. This makes it possible for arithmetic processing devices in various scales including cores and accelerators to execute the process of transformation into the im2col reduced format with little redundancy and the convolution calculation process.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An arithmetic processing device that executes a convolution calculation of a first matrix including a plurality of elements, the arithmetic processing device comprising:
a first memory configured to hold the first matrix;
a second memory configured to hold data obtained by transforming the elements in the first matrix held in the first memory;
a processor configured to transform the elements in the first matrix and cause the second memory to hold the transformed elements by writing each of a plurality of element groups arranged in a row direction, which the plurality of element groups are to be used for a matrix product operation with a filter in each row of the first matrix, to each of a plurality of rows in the second memory in a sequence so that the elements in the plurality of element groups arranged in a column direction of the first matrix sequentially partially overlap with each other; and
an accelerator configured to execute the convolution calculation of the first matrix by executing the matrix product operation of the filter and the plurality of element groups written in the second memory, which the elements of the plurality of element groups partially overlap with each other.

2. The arithmetic processing device according to claim 1,
wherein, in a case where the convolution calculation of a plurality of the matrices is executed by the accelerator, the processor is configured to write the elements at a same position in the element groups at a same position in the plurality of matrices, to a same row in the second memory so that the elements are adjacent to each other.

3. The arithmetic processing device according to claim 2,
wherein the plurality of matrices as transformation targets held in the first memory are in a so-called NHWC format in which the elements are arranged in order of channels which are respectively the plurality of matrices, a height direction of the matrices, a width direction of the matrices, and a batch including the plurality of matrices.

4. The arithmetic processing device according to claim 2,
wherein a plurality of filters to be respectively used for the matrix product operations of the plurality of matrices are held so that elements at the same position in the plurality of filters are held in one row in the second memory so as to be adjacent to each other.

5. The arithmetic processing device according to claim 4,
wherein, in a case where a convolution calculation of a plurality of matrix groups each including the plurality of matrices is executed, the filters respectively for the plurality of matrix groups are held in different rows in the second memory.

6. The arithmetic processing device according to claim 1,
wherein the first matrix is each of a plurality of submatrices into which a second matrix having a size larger than that of the first matrix is divided,
wherein the processor sequentially transforms the elements in the plurality of submatrices,
wherein the accelerator sequentially executes the matrix product operations of the submatrices in which the elements are transformed, and
wherein a second and subsequent transformation of the elements in the submatrices is executed in parallel with the matrix product operation of another one of the submatrices.

7. The arithmetic processing device according to claim 1,
wherein the first matrix includes target data of the matrix product operation and zero padding added to the target data, and
wherein each of the plurality of element groups arranged in the row direction is a row group including one row of the target data and a predetermined number of rows adjacent to both sides of the one row.

8. An arithmetic processing device comprising:
a core group configured to include a plurality of cores each including a processor;
a first memory configured to hold a matrix including a plurality of elements;
a second memory configured to hold data obtained by transforming the elements in the matrix held in the first memory; and
an accelerator configured to execute a matrix product operation,
wherein each of the plurality of cores transforms elements in a plurality of submatrices into which the matrix is divided, writes data obtained by the transforming to the second memory, and then instruct the accelerator to execute the matrix product operation for the transformed data,
wherein the accelerator executes, based on the instruction, the matrix product operation for the transformed data, and writes an execution result to the second memory,
wherein, in a case where there is a submatrix that is not transformed among the plurality of submatrices, any of the plurality of cores performs the transformation, writing of the transformed data to the second memory, and an instruction to execute the matrix product operation for the transformed data, and
wherein, in a case where the transformation of all of the plurality of submatrices is completed, the plurality of cores wait for completion of the matrix product operations by the accelerator.

9. An operating method of an arithmetic processing device that executes a convolution calculation of a matrix including a plurality of elements, and includes a first memory configured to hold the matrix, a second memory configured to hold data obtained by transforming the elements in the matrix held in the first memory, a processor, and an accelerator, the operating method comprising:
transforming the elements in the first matrix and cause the second memory to hold the transformed elements by writing each of a plurality of element groups arranged in a row direction, which the plurality of element groups are to be used for a matrix product operation with a filter in each row of the first matrix, to each of a plurality of rows in the second memory in a sequence so that the elements in the plurality of element groups arranged in a column direction of the first matrix sequentially partially overlap with each other, by the processor, and
executing the convolution calculation of the first matrix by executing the matrix product operation of the filter and the plurality of element groups written in the second memory, which the elements of the plurality of element groups partially overlap with each other, by the accelerator.
